(19) United States
(12) Patent Application Publication
(10) Pub. No.: US 2018/0025700 A1
(43) Pub. Date: Jan. 25, 2018

(54) IMAGE PROCESSING APPARATUS AND DISPLAY APPARATUS

(71) Applicant: CANON KABUSHIKI KAISHA, Tokyo (JP)

(72) Inventors: Yasuo Suzuki, Yokohama-shi (JP); Masaharu Yamagishi, Yokohama-shi (JP)

(21) Appl. No.: 15/651,078

(22) Filed: Jul. 17, 2017

(30) Foreign Application Priority Data
Jul. 22, 2016 (JP) 2016-144282

(51) Int. Cl. G09G 5/02; G06T 5/00

(52) U.S. Cl. CPC G09G 5/02; G06T 5/009; G09G 2320/0626; G06T 2207/20208

(57) ABSTRACT

An image processing apparatus according to the present invention, includes: a determining unit configured to determine a parameter to be used in predetermined image processing in accordance with an operation that is performed by a user after an image based on target image data is displayed on a display unit; a generating unit configured to generate processed image data by applying the predetermined image processing using the parameter to the target image data; an acquiring unit configured to acquire brightness information related to a correspondence relationship between a display brightness of the display unit and a brightness of the processed image data; and a recording unit configured to record, in a storage unit, the processed image data and the brightness information.

### BACKGROUND OF THE INVENTION

### Field of the Invention

The present invention relates to an image processing apparatus and a display apparatus.

### Description of the Related Art

Recently, opportunities to handle image data with a wide dynamic range have increased. For example, with improved light-receiving performance of photographing apparatuses, photographing apparatuses capable of generating image data with a wide dynamic range have increased. Image data with a wide dynamic range is referred to as “high dynamic range (HDR) image data” and the like.

In addition, as gradation characteristics of HDR image data, gradation characteristics similar to log characteristics (log gradation characteristics) are used. Log gradation characteristics refer to gradation characteristics in which a gradation value increases logarithmically with respect to an increase in brightness. In other words, as HDR image data, image data converted with conversion characteristics similar to log characteristics (log gradation characteristics) is used. Conversion characteristics refer to characteristics of a change in a gradation value after conversion with respect to a change in the gradation value before the conversion. Log conversion characteristics refer to conversion characteristics which cause a gradation value after conversion to increase logarithmically with respect to an increase in the gradation value before the conversion. For example, on a film production site, Cineon log characteristics defined based on characteristics of film having a wide dynamic range are used as gradation characteristics and conversion characteristics of HDR image data.

In addition, with improved display performance of display apparatuses, display apparatuses capable of, for example, displaying with high contrast in an order of several hundred thousand to one and displaying with high brightness in an order of several thousand candela have increased. For example, with a liquid crystal display apparatus, high contrast display can be realized by local dimming control using a backlight module which irradiates a rear surface of a liquid crystal panel with light. In addition, high brightness display can be realized by increasing emission brightness (an emission amount) of the backlight module.

Furthermore, studies on an image production work flow for displaying images based on HDR image data on a display apparatus capable of displaying with high contrast and high brightness are being promoted. Conventionally, Rec. 709 and the like are used as transmission standards for transmitting image data to a display apparatus. However, in conventional transmission standards, dynamic ranges are limited to narrow ranges and brightness is limited to low brightness. Therefore, conventionally, image data is converted into Rec. 709 image data by image editing involving range compression for narrowing down a dynamic range and the converted image data is transmitted to a display apparatus. In addition, the display apparatus displays an image using only a part of performance of the display apparatus. In other words, a limitation due to transmission standards creates a loss in the dynamic range of image data.

In consideration thereof, studies on a transmission type which maintains a dynamic range of HDR image data are being promoted. For example, the SMPTE ST 2084 standard (ST2084 standard) is proposed. In the ST2084 standard, a physical brightness of 0 to 10,000 [cd/m²] is converted into a 10-bit gradation value in accordance with a correspondence relationship shown in FIG. 36. Accordingly, HDR image data having log gradation characteristics is obtained. Hereinafter, such HDR image data will be referred to as “HDR brightness image data”. A feature of the ST2084 standard is that “a gradation value of HDR image data can be handled as display brightness of a display apparatus (a display unit)”. “Display brightness” refers to physical brightness on a screen.

However, in a display apparatus, an automatic brightness limiter (ABL) process may be performed for the purposes of power consumption reduction and device protection (Japanese Patent Application Laid-open No. 2005-189636). For example, with the ABL process, in a case where brightness of input image data is high, display brightness is reduced by reducing a current flowing through a display panel. In addition, once the ABL process is performed, even when an image is to be displayed based on HDR brightness image data, display brightness which differs from brightness of the HDR brightness image data ends up being realized.

FIG. 37 shows an example of the ABL process. The example shown in FIG. 37 represents a case where a brightness of no more than 1000 [cd/m²] is used as an upper limit of display brightness. In addition, the example shown in FIG. 37 represents the ABL process of determining the upper limit of the display brightness in accordance with average brightness of the input image data. In a case where the average brightness of the input image data is low, power consumption of the display apparatus is low. Therefore, in the example shown in FIG. 37, in a case where the average brightness of the input image data is low, 1000 [cd/m²] is used as the upper limit of the display brightness. However, in a case where the upper limit of the display brightness is constant, power consumption of the display apparatus increases as the average brightness of the input image data increases. In consideration thereof, in the example shown in FIG. 37, in a case where the average brightness of the input image data is high, lower brightness as compared to a case where the average brightness of the input image data is low is determined as the upper limit of the display brightness. In a case where the upper limit of the display brightness changes, a correspondence relationship between the brightness of HDR brightness image data and the display brightness also changes. Therefore, due to a change in the upper limit of the display brightness, display brightness which differs from the brightness of HDR brightness image data ends up being realized.

As described above, in a case where the ABL process is performed or the like, display brightness which differs from the brightness of HDR brightness image data is realized. In addition, in a case where a user edits the HDR brightness image data based on such display brightness, an unintended editing result (image data with brightness not intended by the user) is obtained. As a result, in a case of using a display apparatus which differs from the display apparatus used for the editing and the like, display with display brightness not intended by the user ends up being realized in a case of displaying the editing result.

### SUMMARY OF THE INVENTION

The present invention in its first aspect provides an image processing apparatus, comprising:

a determining unit configured to determine a parameter to be used in predetermined image processing in accordance with an operation that is performed by a user after an image based on target image data is displayed on a display unit;

a generating unit configured to generate processed image data by applying the predetermined image processing using the parameter determined by the determining unit to the target image data;

an acquiring unit configured to acquire brightness information related to a correspondence relationship between a display brightness of the display unit and a brightness of the processed image data; and

a recording unit configured to record, in a storage unit, the processed image data generated by the generating unit and the brightness information acquired by the acquiring unit.

The present invention in its second aspect provides a display apparatus, comprising:

a determining unit configured to determine, based on a brightness characteristic value of input image data, a correspondence relationship between a display brightness of a display unit and a brightness of the input image data;

the display unit configured to display an image based on the input image data in accordance with the correspondence relationship determined by the determining unit; and

an outputting unit configured to output brightness information related to the correspondence relationship determined by the determining unit, to the display unit or to the outside.

The present invention in its third aspect provides an image processing apparatus, comprising:

a first acquiring unit configured to acquire moving image data;

a second acquiring unit configured to acquire, for each frame of the moving image data acquired by the first acquiring unit, brightness information related to a first correspondence relationship that is a correspondence relationship between a display brightness of a first display unit and a brightness of the moving image data;

a third acquiring unit configured to acquire, for each frame, a brightness characteristic value of the moving image data from the moving image data;

a determining unit configured to determine, for each frame, a second correspondence relationship that is a correspondence relationship between a display brightness of a second display unit and the brightness of the moving image data based on the brightness characteristic value acquired by the third acquiring unit;

a fourth acquiring unit configured to acquire, for each frame, a result of a determination on whether or not the second display unit is capable of displaying an image based on the moving image data with a same display brightness as the display brightness of the first display unit; and

a correcting unit configured to correct, for each frame, the second correspondence relationship based on the result of the determination so that a manner of change in the second correspondence relationship between the frames approaches a manner of change in the first correspondence relationship between the frames.

The present invention in its fourth aspect provides an image processing method, comprising:

a determining step of determining a parameter to be used in predetermined image processing in accordance with an operation that is performed by a user after an image based on target image data is displayed on a display unit;

a generating step of generating processed image data by applying the predetermined image processing using the parameter determined by the determining step to the target image data;

an acquiring step of acquiring brightness information related to a correspondence relationship between a display brightness of the display unit and a brightness of the processed image data; and

a recording step of recording, in a storage unit, the processed image data generated by the generating step and the brightness information acquired by the acquiring step.

The present invention in its fifth aspect provides a method for controlling a display apparatus having a display unit configured to display an image based on input image data, the method comprising:

a determining step of determining, based on a brightness characteristic value of the input image data, a correspondence relationship between a display brightness of the display unit and a brightness of the input image data; and

an outputting step of outputting brightness information related to the correspondence relationship determined by the determining step, to the display unit or to the outside, wherein

the display unit displays the image based on the input image data in accordance with the correspondence relationship determined by the determining step.

The present invention in its sixth aspect provides an image processing method, comprising:

a first acquiring step of acquiring moving image data;

a second acquiring step of acquiring, for each frame of the moving image data acquired by the first acquiring step, brightness information related to a first correspondence relationship that is a correspondence relationship between a display brightness of a first display unit and a brightness of the moving image data;

a third acquiring step of acquiring, for each frame, a brightness characteristic value of the moving image data from the moving image data;

a determining step of determining, for each frame, a second correspondence relationship that is a correspondence relationship between a display brightness of a second display unit and the brightness of the moving image data based on the brightness characteristic value acquired by the third acquiring step;

a fourth acquiring step of acquiring, for each frame, a result of a determination on whether or not the second display unit is capable of displaying an image based on the moving image data with a same display brightness as the display brightness of the first display unit; and

a correcting step of correcting, for each frame, the second correspondence relationship based on the result of the determination so that a manner of change in the second correspondence relationship between the frames approaches a manner of change in the first correspondence relationship between the frames.

The present invention in its seventh aspect provides a non-transitory computer readable medium storing a program for causing a computer to execute the image processing method according to the fourth aspect. The present invention in its eighth aspect provides a non-transitory computer readable medium storing a program for causing a computer to execute the method according to the fifth aspect. The present invention in its ninth aspect provides a non-transitory computer readable medium storing a program for causing a computer to execute the image processing method according to the sixth aspect.

Further features of the present invention will become apparent from the following description of exemplary embodiments with reference to the attached drawings.

### BRIEF DESCRIPTION OF THE DRAWINGS

FIG. 1 is a diagram showing an example of a configuration of a display system according to a first embodiment;

FIG. 2 is a diagram showing an example of a configuration of a display system according to the first embodiment;

FIG. 3 is a diagram showing an example of conversion characteristics of an absolute brightness converting unit according to the first embodiment;

FIG. 4 is a diagram showing an example of conversion characteristics of an absolute brightness converting unit according to the first embodiment;

FIG. 5 is a diagram showing an example of conversion characteristics of a linear conversion unit according to the first embodiment;

FIG. 6 is a diagram showing an example of a loading type according to the first embodiment;

FIG. 7 is a diagram showing an example of a light-emitting region of a backlight module according to the first embodiment;

FIG. 8 is a diagram showing a control example of emission brightness of a backlight module according to the first embodiment;

FIG. 9 is a diagram showing an example of a graphic image according to the first embodiment;

FIG. 10 is a diagram showing an example of a combined image according to the first embodiment;

FIG. 11 is a diagram showing an example of a configuration of a display system according to a second embodiment;

FIG. 12 is a diagram showing an example of conversion characteristics of a conversion lookup table according to the second embodiment;

FIGS. 13A and 13B are diagrams showing examples of conversion characteristics of a display brightness converting unit according to the second embodiment;

FIG. 14 is a diagram showing an example of a configuration of a display system according to a third embodiment;

FIG. 15 is a diagram showing an example of a configuration of a display system according to a fourth embodiment;

FIG. 16 is a diagram showing an example of a configuration of a display apparatus B according to the fourth embodiment;

FIG. 17 is a diagram showing an example of conversion characteristics of a gamma conversion unit according to the fourth embodiment;

FIGS. 18A and 18B are diagrams showing examples of a brightness histogram according to the fourth embodiment;

FIG. 19 is a diagram showing an example of a frame difference histogram according to the fourth embodiment;

FIG. 20 is a diagram showing an example of ABL characteristics of a display apparatus A according to the fourth embodiment;

FIG. 21 is a diagram showing an example of ABL characteristics of the display apparatus B according to the fourth embodiment;

FIG. 22 is a flow chart showing an example of a brightness change scene determination process according to the fourth embodiment;

FIG. 23 is a diagram showing an example of a brightness change scene according to the fourth embodiment;

FIG. 24 is a diagram showing an example of a scene that is not a brightness change scene according to the fourth embodiment;

FIG. 25 is a diagram showing an example of ABL characteristics according to the fourth embodiment;

FIG. 26 is a diagram showing an example of ABL characteristics according to the fourth embodiment;

FIG. 27 is a diagram showing an example of ABL characteristics according to the fourth embodiment;

FIG. 28 is a diagram showing an example of ABL characteristics according to the fourth embodiment;

FIG. 29 is a diagram showing an example of a configuration of a display apparatus B according to a fifth embodiment;

FIGS. 30A and 30B are diagrams showing examples of a gamma curve according to the fifth embodiment;

FIG. 31 is a diagram showing an example of a configuration of a display apparatus B according to a sixth embodiment;

FIG. 32 is a diagram showing an example of ABL characteristics according to the sixth embodiment;

FIG. 33 is a diagram showing an example of a configuration of a display system according to a seventh embodiment;

FIG. 34 is a diagram showing an example of scene division according to the seventh embodiment;

FIG. 35 is a diagram showing an example of a configuration of a display apparatus B according to the seventh embodiment;

FIG. 36 is a diagram showing an example of a correspondence relationship between brightness and gradation values; and

FIG. 37 is a diagram showing an example of an ABL process.

### DESCRIPTION OF THE EMBODIMENTS

### First Embodiment

A first embodiment of the present invention will be described below. Moreover, while an example will be hereinafter described in which a display unit according to the present embodiment is a display apparatus separate from an image processing apparatus according to the present embodiment, the display unit may alternatively constitute a part of the image processing apparatus. In addition, while an example in which a display apparatus (a display unit) is a liquid crystal display apparatus having a backlight module and a liquid crystal panel will be described below, the display apparatus is not limited to a liquid crystal display apparatus. For example, other display apparatuses including a light-emitting unit and a display panel which displays images by transmitting light from the light-emitting unit may be used. Specifically, a micro electro mechanical system (MEMS) shutter type display apparatus which uses a MEMS shutter as a display element may be used. A self-luminous display apparatus may also be used. Specifically, an organic electro-luminescence (EL) display apparatus, a plasma display apparatus, and the like may be used. As the image processing apparatus according to the present embodiment, for example, a personal computer, a display apparatus, and the like can be used.

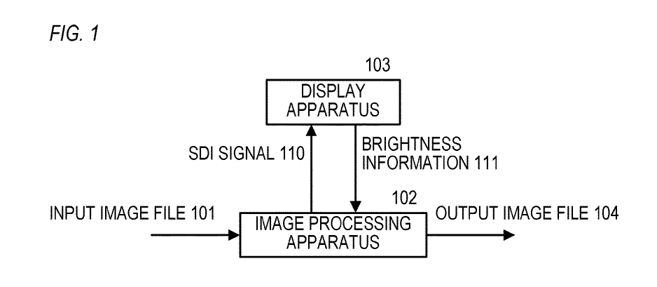

FIG. 1 is a diagram showing an example of a rough configuration of a display system (an image processing system) according to the present embodiment. As shown in FIG. 1, the display system according to the present embodiment includes an image processing apparatus 102 and a display apparatus 103.

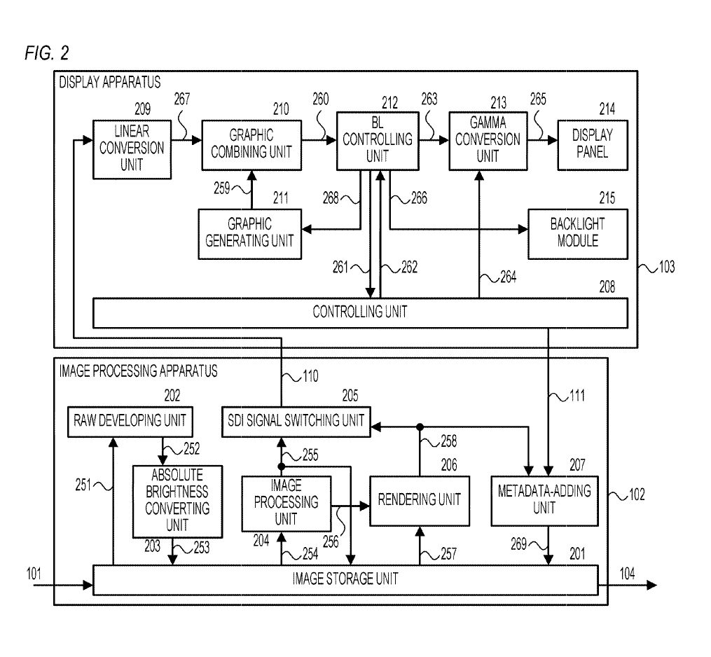

FIG. 2 is a diagram showing an example of a detailed configuration of the display system according to the present embodiment. As shown in FIG. 2, the image processing apparatus 102 includes an image storage unit 201, a RAW developing unit 202, an absolute brightness converting unit 203, an image processing unit 204, an SDI signal switching unit 205, a rendering unit 206, and a metadata-adding unit 207. In addition, the display apparatus 103 includes a controlling unit 208, a linear conversion unit 209, a graphic combining unit 210, a graphic generating unit 211, a BL controlling unit 212, a gamma conversion unit 213, a liquid crystal panel 214, and a backlight module 215.

In the present embodiment, photographed image data (image data representing an image of an object) is generated by photography performed using a photographing apparatus. In addition, the photographed image data is input to the image processing apparatus 102 and stored in the image storage unit 201. Specifically, an input image file 101 that is photographed image data in a file format is input to the image processing apparatus 102 and stored in the image storage unit 201.

While the format of the photographed image data included in the input image file 101 is not particularly limited, in the present embodiment, the photographed image data included in the input image file 101 is RAW image data which has an output value of an imaging sensor of the photographing apparatus as a gradation value. Therefore, the input image file 101 can also be referred to as “a RAW image file”. In RAW image data, an array of R pixels (pixels corresponding to the color red), an array of G pixels (pixels corresponding to the color green), and an array of B pixels (pixels corresponding to the color blue) are dependent on the photographing apparatus.

In addition, while the number of pieces of image data included in the input image file 101 is not particularly limited, in the present embodiment, a plurality of pieces of image data respectively corresponding to a plurality of frames are included in the input image file 101 as photographed image data. In other words, in the present embodiment, the photographed image data included in the input image file 101 is moving image data.

Moreover, a single piece of still image data may be included in the input image file 101 as photographed image data or each of a plurality of pieces of still image data may be included in the input image file 101 as photographed image data. In addition, image data input to the image processing apparatus 102 is not limited to photographed image data. For example, computer graphic image data, illustration image data, and the like may be input to the image processing apparatus 102.

The image storage unit 201 is a storage unit capable of storing image data (an image file) and the like. As the image storage unit 201, a magnetic disk, a semiconductor memory, an optical disk, or the like can be used. In the present embodiment, image data can be written into the image storage unit 201, image data can be read from the image storage unit 201, and the like. In the present embodiment, at least one image file (the input image file 101) is stored in the image storage unit 201 in advance. Moreover, the image storage unit 201 may be a storage unit built into the image processing apparatus 102 or a storage unit (a storage apparatus) that is attachable to and detachable from the image processing apparatus 102.

The RAW developing unit 202 reads image data (RAW image data; a RAW image file) 251 stored in the image storage unit 201 from the image storage unit 201. The RAW image data 251 read by the RAW developing unit 202 is a processing target of the display system according to the present embodiment. Hereinafter, image data that is a processing target of the display system according to the present embodiment will be referred to as “target image data”. By applying a RAW development process to the read RAW image data 251, the RAW developing unit 202 converts the read RAW image data into RGB image data 252. In addition, the RAW developing unit 202 outputs the RGB image data 252. The RAW image data 251 is RAW image data included in the input image file 101. In the present embodiment, the RAW developing unit 202 individually performs the process described above on each of a plurality of frames of the moving image data included in the input image file 101. Moreover, a preferable method of the RAW development process is determined by a manufacturer of an imaging apparatus.

The absolute brightness converting unit 203 converts the RGB image data 252 into HDR brightness image data 253 and stores (records) the HDR brightness image data 253 in the image storage unit 201. Details of the conversion from the RGB image data 252 into the HDR brightness image data 253 will be provided later.

The image processing unit 204 determines a parameter (a processing parameter) to be used in predetermined image processing. In addition, the image processing unit 204 reads pre-editing image data 254 from the image storage unit 201 and applies the predetermined image processing to the pre-editing image data 254 using the determined processing parameter. Accordingly, post-editing image data 255 (processed image data) is generated. The image processing unit 204 outputs the post-editing image data 255 and the determined (set) processing parameter 256. The pre-editing image data 254 is the same image data as the HDR brightness image data 253.

For example, initially, the image processing unit 204 performs the predetermined image processing using an initial value of the processing parameter. The initial value refers to the processing parameter with an unchanged gradation value or the like. Subsequently, the image processing unit 204 changes (determines) the processing parameter in accordance with an operation performed by a user on the image processing apparatus 102 after having confirmed display (display of an image based on target image data) on the display apparatus 103. Then, the image processing unit 204 performs the predetermined image processing using the changed processing parameter. Alternatively, the image processing unit 204 may initially omit the predetermined image processing and output the same image data as the pre-editing image data 254 as the post-editing image data 255.

The predetermined image processing and the processing parameter are not particularly limited. For example, the predetermined image processing includes at least any of a multiplication process in which a gradation value is multiplied by a gain value, an addition process in which an offset value is added to a gradation value, and a conversion process (such as a gamma conversion process) in which gradation characteristics are converted. In addition, the processing parameter includes at least any of the gain value of the multiplication process, the offset value of the addition process, and conversion characteristics of the conversion process (such as a gamma value of a gamma conversion process).

Individually determining a processing parameter for all of the frames constituting the moving image data presents a significant burden on the user and is therefore unfavorable. Therefore, in the image processing unit 204, for each of a plurality of scenes in the moving image data, a processing parameter corresponding to the scene is determined and pre-editing image data 254 representing the scene is read. “Pre-editing image data 254 representing a scene” refers to “any of the plurality of pieces of HDR brightness image data 234 respectively corresponding to a plurality of frames included in the scene”.

The rendering unit 206 reads pre-rendering image data 257 from the image storage unit 201 and applies a rendering process to the pre-rendering image data 257. Accordingly, post-rendering image data 258 (processed image data) is generated. The rendering unit 206 outputs the post-rendering image data 258. The pre-rendering image data 257 is the same image data as the HDR brightness image data 253. In the rendering process, for each frame of the moving image data, the predetermined image processing is applied to the pre-rendering image data 257 of the frame (a scene including the frame) using the processing parameter 256 of the frame. Therefore, the rendering process is performed after the processing parameter 256 is determined (set) for all scenes.

The SDI signal switching unit 205 selects one of the post-editing image data 255 and the post-rendering image data 258 and outputs the selected image data. In the present embodiment, the SDI signal switching unit 205 performs a serial-digital interface (SDI) transmission of the selected image data to the display apparatus 103. Specifically, the SDI signal switching unit 205 converts the selected image data into an SDI signal 110 and outputs the SDI signal 110.

The controlling unit 208 controls processes of the respective functional units of the display apparatus 103. For example, the controlling unit 208 sets a control parameter used by each functional unit of the display apparatus 103. Specifically, in a case of starting up the display apparatus 103, the controlling unit 208 reads an initial value of a control parameter from a storage unit (such as a nonvolatile memory) (not shown) and sets the read control parameter. In addition, the controlling unit 208 changes the set control parameter in accordance with an operation performed by the user on the display apparatus 103. A previously-used control parameter may be set instead of the initial value of the control parameter upon startup of the display apparatus 103.

In the present embodiment, the SDI signal 110 (the post-editing image data 255 or the post-rendering image data 258) which is input image data of the display apparatus 103 has gradation characteristics in which a gradation value increases nonlinearly with respect to an increase in brightness. Specifically, the SDI signal 110 has log gradation characteristics. Log gradation characteristics refer to gradation characteristics in which a gradation value increases logarithmically with respect to an increase in brightness. The linear conversion unit 209 converts the gradation characteristics of the SDI signal 110 into linear gradation characteristics. As a result, linear image data 267 is generated. Linear gradation characteristics refer to gradation characteristics in which a gradation value increases linearly with respect to an increase in brightness. In addition, the linear conversion unit 209 outputs the linear image data 267.

The graphic generating unit 211 generates graphic image data 259 representing a graphic image and outputs the graphic image data 259. In the present embodiment, the graphic generating unit 211 generates the graphic image data 259 representing a graphic image related to a correspondence relationship between display brightness (physical brightness on a screen) of the display apparatus 103 and brightness of the linear image data 267. Specifically, the graphic generating unit 211 acquires average brightness 268 from the BL controlling unit 212 and generates the graphic image data 259 using the average brightness 268. Details of generation of the graphic image data 259 will be provided later.

Moreover, the term “brightness of the linear image data 267” may be rephrased as “brightness of target image data”, “brightness of processed image data”, “brightness of input image data of the display apparatus 103”, “brightness of combined image data 260 (to be described later)”, and the like. In addition, the graphic image data 259 is not limited to graphic image data representing a graphic image related to the correspondence relationship between the display brightness of the display apparatus 103 and the brightness of the linear image data 267. The graphic image data 259 may be prepared in advance.

The graphic combining unit 210 generates combined image data 260 by combining the graphic image data 259 with the input image data of the display apparatus 103 and outputs the combined image data 260. In the present embodiment, the graphic combining unit 210 generates the combined image data 260 by combining the graphic image data 259 with the linear image data 267. As described above, the graphic generating unit 211 generates the graphic image data 259 using the average brightness 268. In addition, the average brightness 268 is obtained using the combined image data 260. Therefore, initially (before the graphic image data 259 is generated), the graphic combining unit 210 outputs same image data as the linear image data 267 as the combined image data 260.

While the combined image data 260 is not particularly limited, in the present embodiment, the combined image data 260 represents a combined image in which an input image represented by the input image data of the display apparatus 103 and a graphic image represented by the graphic image data 259 are arranged. Specifically, the combined image data 260 represents a combined image in which a graphic image is overlapped with a part of an input image. Moreover, an arrangement of the input image and the graphic image is not particularly limited. For example, the input image and the graphic image may be arranged so that the graphic image does not overlap with the input image.

The BL controlling unit 212 acquires a brightness characteristic value (a characteristic value related to brightness) of the input image data of the display apparatus 103 from the input image data. In the present embodiment, the BL controlling unit 212 acquires a brightness characteristic value of the combined image data 260 from the combined image data 260. Specifically, the BL controlling unit 212 acquires the average brightness (an average value of brightness of an entire image) 268 of the combined image data 260 as the brightness characteristic value of the combined image data 260. In addition, the BL controlling unit 212 outputs the acquired average brightness 268. Moreover, the brightness characteristic value is not limited to the average brightness 268. A brightness histogram, other brightness representative values (maximum brightness, minimum brightness, intermediate brightness, modal brightness, and the like), and the like may be acquired as the brightness characteristic value.

In addition, based on the acquired brightness characteristic value (the average brightness 268), the BL controlling unit 212 determines a correspondence relationship between the display brightness of the display apparatus 103 and the brightness of the linear image data 267. In the present embodiment, the BL controlling unit 212 determines an upper limit of the display brightness (an upper limit display brightness 261) of the display apparatus 103 in accordance with the average brightness 268. By determining an upper limit of the display brightness of the display apparatus 103, the correspondence relationship between the display brightness of the display apparatus 103 and the brightness of the linear image data 267 is determined. In addition, the BL controlling unit 212 outputs the upper limit display brightness 261.

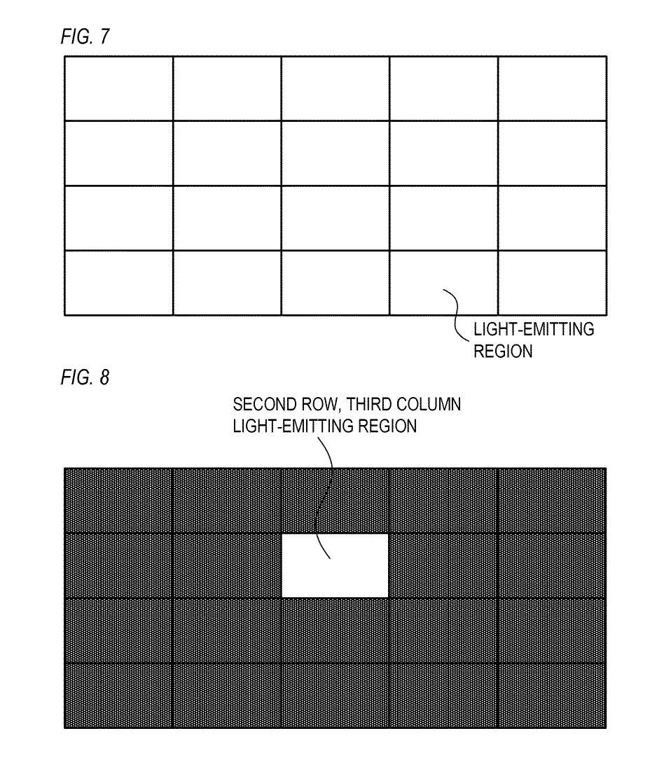

Furthermore, based on the combined image data 260 and the upper limit display brightness 261 (the correspondence relationship between the display brightness of the display apparatus 103 and the brightness of the linear image data 267), the BL controlling unit 212 generates a BL control signal 266 and BL image data 263. In addition, the BL controlling unit 212 outputs the BL control signal 266 and the BL image data 263. For example, the BL controlling unit 212 generates the BL control signal 266 based on the combined image data 260 and the upper limit display brightness 261, and generates the BL image data 263 by correcting the combined image data 260 based on the BL control signal 266. The BL control signal 266 is a control signal corresponding to the emission brightness (the emission amount) of the backlight module 215. In the present embodiment, as shown in FIG. 7, the backlight module 215 has a plurality of light-emitting regions. Furthermore, as the BL control signal 266, a control signal which individually controls the emission brightness of each light-emitting region is generated.

In the present embodiment, the controlling unit 208 sets loading type information 262 indicating a loading type to the BL controlling unit 212. For example, the controlling unit 208 determines (selects) a loading type in accordance with an operation performed by the user on the display apparatus 103 and sets the loading type information 262 indicating the determined loading type to the BL controlling unit 212. A loading type refers to a type of a change in the display brightness of the display apparatus 103 with respect to a change in the brightness of the linear image data 267. Details of the loading type will be provided later. Furthermore, in the present embodiment, the BL controlling unit 212 generates the BL control signal 266 and the BL image data 263 based on the combined image data 260, the upper limit display brightness 261, and the loading type information 262.

In the present embodiment, the controlling unit 208 sets a gamma value 264 (a value indicating conversion characteristics for converting gradation characteristics of image data) to the gamma conversion unit 213. The gamma conversion unit 213 generates gamma image data 265 by applying a gamma conversion process using the gamma value 264 to the BL image data 263. In addition, the gamma conversion unit 213 outputs the gamma image data 265. In the present embodiment, the gamma value 264 is a gamma value for converting gradation characteristics of image data from linear characteristics into gradation characteristics corresponding to the liquid crystal panel 214. Therefore, due to the gamma conversion process using the gamma value 264, the BL image data 263 having linear characteristics is converted into the gamma image data 265 having the gradation characteristics of the liquid crystal panel 214.

Due to the liquid crystal panel 214 and the backlight module 215, an image based on the input image data of the display apparatus 103 is displayed. Specifically, transmittance of the liquid crystal panel 214 is controlled to transmittance in accordance with the gamma image data 265. In addition, the backlight module 215 emits light at emission brightness in accordance with the BL control signal 266. An image based on the input image data of the display apparatus 103 is displayed as light from the backlight module 215 is transmitted through the liquid crystal panel 214. Specifically, an image based on the combined image data 260 is displayed. In the present embodiment, an image based on the input image data is displayed in accordance with the upper limit display brightness 261 (the correspondence relationship between the display brightness of the display apparatus 103 and the brightness of the linear image data 267). Specifically, the BL control signal 266 and the BL image data 263 are generated so that an image based on the input image data is displayed in accordance with the upper limit display brightness 261.

The controlling unit 208 generates brightness information 111 related to the correspondence relationship between the display brightness of the display apparatus 103 and the brightness of the linear image data 267. In addition, the controlling unit 208 outputs data based on the input image data of the display apparatus 103 and the brightness information 111. In the present embodiment, the controlling unit 208 outputs the brightness information 111.

A method of generating the brightness information 111 is not particularly limited. In the present embodiment, the upper limit display brightness 261 (the correspondence relationship between the display brightness of the display apparatus 103 and the brightness of the linear image data 267) is dependent on a brightness characteristic value (the average brightness 268). Therefore, the controlling unit 208 generates the brightness information 111 based on the brightness characteristic value (the average brightness 268). Specifically, the controlling unit 208 generates brightness information 111 based on the upper limit display brightness 261 (the correspondence relationship between the display brightness of the display apparatus 103 and the brightness of the linear image data 267), the loading type information 262, and the like. For example, the brightness information 111 indicates at least any of an upper limit of the display brightness of the display apparatus 103, a lower limit of the display brightness of the display apparatus 103, the loading type, and a correspondence relationship between the brightness characteristic value of the linear image data 267 and a range of the display brightness. Moreover, the term “a brightness characteristic value of the linear image data 267” may be rephrased as “a brightness characteristic value of target image data”, “a brightness characteristic value of processed image data”, “a brightness characteristic value of input image data of the display apparatus 103”, “a brightness characteristic value of the combined image data 260”, and the like.

The metadata-adding unit 207 acquires the brightness information 111. In addition, the metadata-adding unit 207 records (stores), in the image storage unit 201, data based on processed image data (the post-rendering image data 258) and the brightness information 111. In the present embodiment, the metadata-adding unit 207 records the post-rendering image data 258 and the brightness information 111 in the image storage unit 201 in association with each other. Specifically, the metadata-adding unit 207 adds the brightness information 111 as metadata to the post-rendering image data 258. In addition, the metadata-adding unit 207 records, in the image storage unit 201, the post-rendering image data 258 after of the brightness information 111 is added thereto as post-metadata addition image data 269. In the present embodiment, the moving image data (post-rendering moving image data) including the post-metadata addition image data 269 of each frame is recorded in a file format. An output image file 104 that is the post-rendering moving image data in a file format is read from the image storage unit 201 in accordance with an operation performed by the user on the image processing apparatus 102 at an arbitrary timing.

Moreover, a method of association is not particularly limited. For example, the post-rendering image data 258 and the brightness information 111 may be associated with each other by adding, to at least one of the post-rendering image data 258 and the brightness information 111, identification information for identifying the other of the post-rendering image data 258 and the brightness information 111.

Specific examples of processes by the respective functional units described above will now be described.

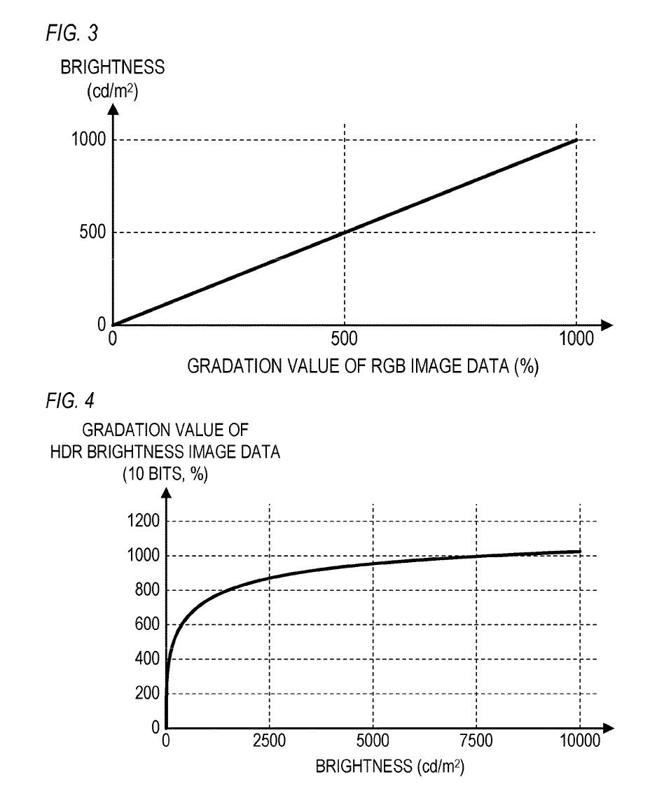

A range of a gradation value (an R value, a G value, and a B value) of the RGB image data 252 corresponds to a range of an output value of an imaging sensor of the photographing apparatus. In this case, the range of the gradation value of the RGB image data 252 is assumed to be 0 to 1000% and a gradation value (a gradation value of the RGB image data 252) corresponding to reference white is assumed to be 100%. The absolute brightness converting unit 203 converts the gradation value of the RGB image data 252 into physical brightness [cd/m²] in accordance with the conversion characteristics shown in FIG. 3. While physical brightness increases linearly with respect to an increase in the gradation value of the RGB image data 252 in the conversion characteristics shown in FIG. 3, conversion characteristics for converting the gradation value of the RGB image data 252 into physical brightness is not limited to the conversion characteristics shown in FIG. 3.

In addition, the absolute brightness converting unit 203 converts the obtained brightness (physical brightness) into a 10-bit gradation value in accordance with the conversion characteristics shown in FIG. 4. As a result, the HDR brightness image data 253 is generated. The conversion characteristics shown in FIG. 4 are log conversion characteristics in which a gradation value after conversion increases logarithmically with respect to an increase in the gradation value (physical brightness) before the conversion. By using the conversion characteristics shown in FIG. 4, the HDR brightness image data 253 having log gradation characteristics is generated. The log conversion characteristics shown in FIG. 4 is, for example, conversion characteristics defined in the SMPTE ST 2084 standard (ST2084 standard). Moreover, conversion characteristics for converting a physical brightness into a gradation value of the HDR brightness image data 253 is not limited to the conversion characteristics shown in FIG. 4. In addition, the number of bits of the gradation value of the HDR brightness image data 253 may be larger or smaller than 10 bits.

The image processing unit 204 reads the HDR brightness image data 253 of a scene with a processing parameter which the user wishes to adjust from the image storage unit 201 as the pre-editing image data 254. In addition, the image processing unit 204 generates the post-editing image data 255 by applying predetermined image processing to the read pre-editing image data 254. Subsequently, an image based on the generated post-editing image data 255 is displayed by the display apparatus 103. While the predetermined image processing may be applied only to a part of image regions, in the present embodiment, the predetermined image processing is applied to all image regions.

Next, while confirming the display by the display apparatus 103, the user performs an operation (an adjustment operation) for adjusting a processing parameter on the image processing apparatus 102. The image processing unit 204 changes the processing parameter in accordance with the adjustment operation and applies predetermined image processing to the pre-editing image data 254 using the changed processing parameter. Accordingly, the post-editing image data 255 is updated and the display by the display apparatus 103 is updated.

Subsequently, the user performs an operation (a setting operation) for setting a processing parameter on the image processing apparatus 102. In accordance with the setting operation, the image processing unit 204 outputs the processing parameter currently being used as the processing parameter 256. For example, information describing a processing parameter and a frame number of the pre-editing image data 254 is output as the processing parameter 256. In a case where an adjustment of a processing parameter is performed for each of a plurality of pieces of the pre-editing image data 254, information describing a combination of a processing parameter and a frame number is output as the processing parameter 256 for each of the plurality of pieces of the pre-editing image data 254. Operations such as an adjustment operation and a setting operation are performed using, for example, a controller connected to the image processing apparatus 102.

The rendering unit 206 reads HDR brightness image data 253 of all frames of the moving image data that is target image data from the image storage unit 201 as pre-rendering image data 257. Subsequently, using the processing parameter 256 (a processing parameter corresponding to the read pre-rendering image data 257), the rendering unit 206 applies predetermined image processing to the read pre-rendering image data 257. Accordingly, the post-rendering image data 258 is generated.

The SDI signal switching unit 205 selects one of the post-editing image data 255 and the post-rendering image data 258 and outputs the selected image data as the SDI signal 110. For example, during a period in which an adjustment of a processing parameter is being performed, the SDI signal switching unit 205 selects the post-editing image data 255, and during a period after a rendering process, the SDI signal switching unit 205 selects the post-rendering image data 258. In addition, information indicating a selection result of image data is described in an ancillary area of the SDI signal 110 and transmitted together with the selected image data. “Information indicating a selection result of image data” may be rephrased as “information indicating whether image data included in the SDI signal 110 is the post-editing image data 255 or the post-rendering image data 258”.

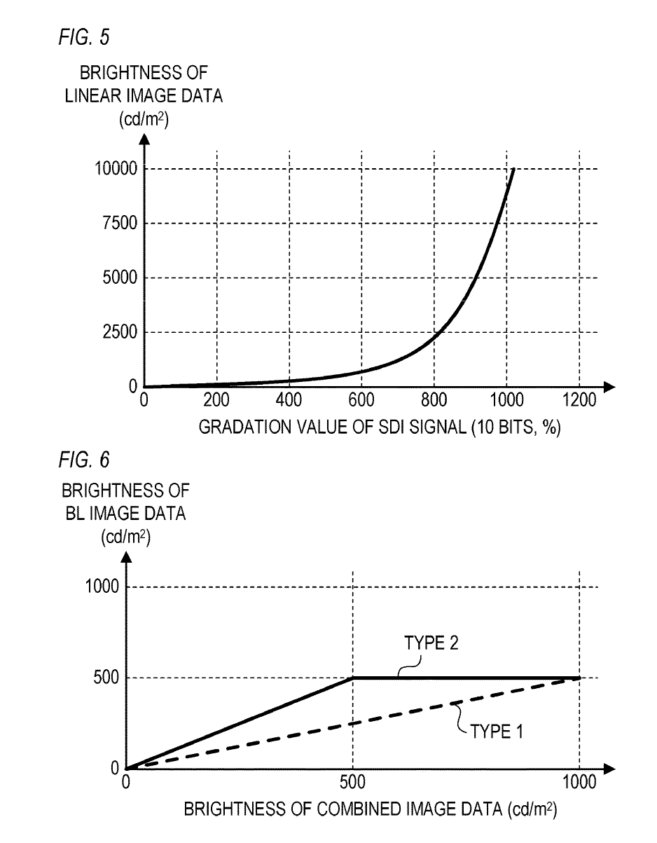

The linear conversion unit 209 converts gradation characteristics of the SDI signal 110 from log gradation characteristics into linear gradation characteristics in accordance with the conversion characteristics shown in FIG. 5. As a result, the linear image data 267 is generated. The conversion characteristics shown in FIG. 5 are reverse characteristics of the conversion characteristics shown in FIG. 4. An input value (a gradation value before conversion) of the conversion characteristics shown in FIG. 5 corresponds to an output value (a gradation value after conversion) of the conversion characteristics shown in FIG. 4, and an output value of the conversion characteristics shown in FIG. 5 corresponds to an input value of the conversion characteristics shown in FIG. 4.

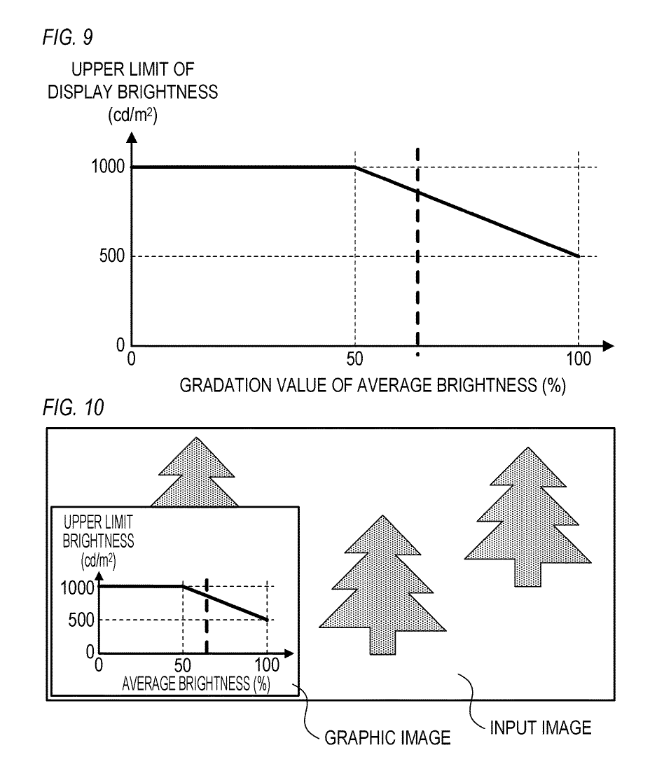

The graphic generating unit 211 acquires the average brightness 268 from the BL controlling unit 212 and generates the graphic image data 259 using the average brightness 268. In this case, it is assumed that a range of the gradation value of the linear image data 267 (and the combined image data 260) is 0 to 100% and a gradation value of 0 to 100% is obtained as the average brightness 268. In addition, a range of an upper limit of the display brightness of the display apparatus 103 is assumed to be 500 to 1000 [cd/m²]. Furthermore, in the present embodiment, the graphic image data 259 representing a graphic image such as that shown in FIG. 9 is generated.

A horizontal axis in FIG. 9 indicates a gradation value (%) corresponding to the average brightness 268 and a vertical axis in FIG. 9 indicates an upper limit (cd/m²) of the display brightness of the display apparatus 103. A thick solid line in FIG. 9 indicates a correspondence relationship between a range of the display brightness of the display apparatus 103 and the average brightness 268. Specifically, the thick solid line in FIG. 9 indicates a correspondence relationship between the upper limit of the display brightness of the display apparatus 103 and the average brightness 268. A thick dashed line in FIG. 9 indicates a correspondence relationship between the average brightness 268 output from the BL controlling unit 212 and the upper limit of the display brightness of the display apparatus 103. In other words, the thick dashed line in FIG. 9 indicates the current upper limit display brightness 261. A drawing position of the thick dashed line in FIG. 9 is determined in accordance with the average brightness 268 output from the BL controlling unit 212.

The graphic combining unit 210 generates the combined image data 260 by combining the graphic image data 259 with the linear image data 267. In the present embodiment, as shown in FIG. 10, the combined image data 260 is generated so that an image (input image) based on the linear image data 267 is displayed across an entire screen and an image (the graphic image shown in FIG. 9) based on the graphic image data 259 is displayed in apart of the screen. According to the display in FIG. 10, the user can not only confirm a change in an input image attributable to a change in a processing parameter but can also confirm the current upper limit display brightness 261 and the like.

The BL controlling unit 212 generates the BL control signal 266 and the BL image data 263 based on the combined image data 260, the upper limit display brightness 261, and the loading type information 262. In the present embodiment, the BL controlling unit 212 generates the BL control signal 266 based on the combined image data 260 and the upper limit display brightness 261. For example, the BL controlling unit 212 generates the BL control signal 266 so that the emission brightness of a light-emitting region corresponding to a bright image region (a part of an image region of the combined image data 260) is controlled to a higher emission brightness than the emission brightness of a light-emitting region corresponding to a dark image region. Specifically, for each of a plurality of image regions corresponding to a plurality of light-emitting regions, the BL controlling unit 212 acquires a brightness characteristic value (an average brightness in an image region corresponding to a light-emitting region) of the combined image data 260 from the combined image data 260. In addition, for each of the plurality of light-emitting regions, the BL controlling unit 212 determines higher emission brightness in a case where the average brightness acquired with respect to a corresponding image region is higher. Subsequently, the BL controlling unit 212 generates the BL control signal 266 in accordance with the emission brightness (determined emission brightness) of each light-emitting region.

A case where an image region corresponding to a second row, third column light-emitting region in FIG. is bright and image regions corresponding to other light-emitting regions in FIG. 7 are dark will now be considered. In this case, as shown in FIG. 8, the BL control signal 266 is generated so that the emission brightness of the second row, third column light-emitting region is controlled to high emission brightness and the emission brightness of the other light-emitting regions are controlled to low emission brightness.

By having the emission brightness of each light-emitting region individually controlled using the BL control signal 266 generated as described above, a contrast of a display image (an image displayed on a screen) can be improved many times over as compared to a case where the emission brightness of each light-emitting region is not individually controlled using the BL control signal 266. Moreover, the emission brightness of all light-emitting regions may be controlled to the same emission brightness or the backlight module 215 may include a single light-emitting region. In such a case, for example, the emission brightness is controlled to high emission brightness in a case where the average brightness of an entire image is high and the emission brightness is controlled to low emission brightness in a case where the average brightness of the entire image is low.

A case where the upper limit of the display brightness of the display apparatus 103 is constant will now be considered. In this case, an increase in the average brightness (an average value of the brightness of the entire image) 268 of the combined image data 260 causes an increase in power consumption of the display apparatus 103, a rise in the temperature of the display apparatus 103, an increase in a rate of deterioration of display elements of the display apparatus 103, and the like. In consideration thereof, the display apparatus 103 performs an ABL (Automatic Brightness Limiter) process for the purposes of power consumption reduction and device protection. In the present embodiment, a process of reducing display brightness by reducing a current flowing through the backlight module 215 is performed as the ABL process.

Specifically, the BL controlling unit 212 determines the upper limit display brightness 261 from the average brightness 268 according to the correspondence relationship (the thick solid line) shown in FIG. 9. The correspondence relationship between the average brightness 268 and the upper limit display brightness 261 is not particularly limited. In FIG. 9, in a case where the gradation value of the average brightness 268 is no more than 50%, the upper limit display brightness 261 of 1000 [cd/m²] is determined. In addition, in a case where the gradation value of the average brightness 268 is at least 50%, the upper limit display brightness 261 is determined so that the upper limit display brightness 261 declines linearly from 1000 [cd/m²] to 500 [cd/m²] as the gradation value of the average brightness 268 increases from 50% to 100%. Furthermore, the BL controlling unit 212 generates the BL control signal 266 so that an upper limit of the emission brightness of a light-emitting region is limited to an emission brightness corresponding to the upper limit display brightness 261 (for example, an emission brightness that is equivalent to the upper limit display brightness 261 or an emission brightness that is slightly higher than the upper limit display brightness 261).

After the BL control signal 266 is generated, the BL controlling unit 212 generates the BL image data 263 by correcting the combined image data 260 based on the BL control signal 266 and the loading type information 262. FIG. 6 shows an example of a correspondence relationship among the brightness of the combined image data 260, the brightness of the BL image data 263, and a loading type. A horizontal axis in FIG. 6 represents the brightness of the combined image data 260 and a vertical axis in FIG. 6 represents the brightness of the BL image data 263. The brightness of the BL image data 263 is a brightness which takes the BL control signal 266 (the emission brightness of each light-emitting region) into consideration. The “brightness of the BL image data 263” can be rephrased as “the display brightness of the display apparatus 103”. FIG. 6 shows an example of a case where the upper limit display brightness is 500 [cd/m²]. In the example in FIG. 6, two types 1 and 2 are shown as loading types.

The type 1 is a type which compresses an entire range of the brightness of the combined image data 260. For example, the type 1 is a type which obtains the brightness of the BL image data 263 by multiplying the brightness of the combined image data 260 with a gain value (a gain value not dependent on the brightness of the combined image data 260). With the type 1, the brightness of the BL image data 263 increases linearly with respect to an increase in the brightness of the combined image data 260. According to the type 1, although same display brightness as the brightness of the combined image data 260 cannot be realized, an occurrence of gradation loss can be suppressed.

In the type 2, with respect to the brightness of the combined image data 260 within a range of the display brightness of the display apparatus 103, same brightness as the brightness (the brightness of the combined image data 260) is associated as the brightness of the BL image data 263. In addition, with respect to brightness of the combined image data 260 outside of the range of the display brightness of the display apparatus 103, an upper limit or a lower limit of the display brightness of the display apparatus 103 is associated as the brightness of the BL image data 263.

Specifically, as shown in FIG. 6, with respect to the brightness of the combined image data 260 which is higher than the upper limit of the display brightness of the display apparatus 103, the upper limit of the display brightness of the display apparatus 103 is associated as the brightness of the BL image data 263. There may be cases where there exists brightness of the combined image data 260 which is lower than the lower limit of the display brightness of the display apparatus 103. In such a case, with respect to the brightness of the combined image data 260 which is lower than the lower limit of the display brightness of the display apparatus 103, the lower limit of the display brightness of the display apparatus 103 is associated as the brightness of the BL image data 263.

According to the type 2, gradation loss occurs in an image region (an image region of the combined image data 260) having brightness outside of the range of the display brightness of the display apparatus 103. However, the same display brightness as the brightness of the combined image data 260 can be realized in an image region (an image region of the combined image data 260) having brightness within the range of the display brightness of the display apparatus 103.

Moreover, a loading type is not limited to the types 1 and 2 described above. For example, a type having characteristics obtained by a weighted average of the characteristics of the type 1 and the characteristics of the type 2 may be used.

The gamma conversion unit 213 generates gamma image data 265 by applying a gamma conversion process using the gamma value 264 to the BL image data 263. As described above, the gamma value 264 is a gamma value for converting gradation characteristics of image data from linear characteristics into gradation characteristics corresponding to the liquid crystal panel 214. For example, the gamma value 264 is 1/2.2.

The controlling unit 208 generates the brightness information 111 and outputs the brightness information 111 to the image processing apparatus 102. In the present embodiment, the brightness information 111 is transmitted using a transmission path which differs from the transmission path of the SDI signal 110. For example, the brightness information 111 is transmitted using a universal serial bus (USB) cable.

With the display apparatus 103, one of display of an image based on the input image data and output of brightness information 111 (data based on the input image data and the brightness information 111) can be omitted. Only a part of the frames of the moving image data is used for adjustment of a processing parameter. On the other hand, the brightness information 111 is favorably individually acquired for all of the frames of the moving image data. For this reason, in the present embodiment, during a period in which the SDI signal switching unit 205 selects and outputs the post-rendering image data 258, the brightness information 111 is generated based on the post-rendering image data 258 and then output. Whether or not the post-rendering image data 258 is selected by the SDI signal switching unit 205 can be determined from information described in the ancillary area of the SDI signal 110. During a period in which the SDI signal switching unit 205 selects and outputs the post-editing image data 255, the process of generating and outputting the brightness information 111 is omitted.

Moreover, display of an image based on the post-editing image data 255 may be performed only during the period in which the SDI signal switching unit 205 selects and outputs the post-editing image data 255. In addition, during the period in which the SDI signal switching unit 205 selects and outputs the post-rendering image data 258, display of an image based on the post-rendering image data 258 may be omitted.

The metadata-adding unit 207 adds the brightness information 111 as metadata to the post-rendering image data 258 for each frame of the moving image data that is target image data. In addition, the metadata-adding unit 207 records, in the image storage unit 201, the post-rendering image data 258 after addition of the brightness information 111 thereto as post-metadata addition image data 269. Specifically, the metadata-adding unit 207 records the moving image data (post-rendering moving image data) including the post-metadata addition image data 269 of each frame in a file format.

The output image file 104 that is the post-rendering moving image data in a file format is read from the image storage unit 201 in accordance with an operation performed by the user on the image processing apparatus 102 at an arbitrary timing. The read output image file 104 is, for example, converted into a radio wave of a television broadcast and distributed to television apparatuses in general households. Moreover, the apparatuses to which the output image file 104 is distributed are not limited to television apparatuses. For example, the output image file 104 may be displayed on other display apparatuses which display an image based on an image file.

In a case where a television apparatus having received the output image file 104 displays an image based on image data of the output image file 104, the television apparatus uses the metadata added to the output image file 104 to apply preferable image processing to the image data of the output image file 104. Specifically, image processing using the brightness information 111 (the loading type information 262, the upper limit display brightness 261, and the like) is performed so that the image of the output image file 104 is displayed with same display brightness as the display brightness during parameter adjustment (the display brightness of the display apparatus 103). In addition, the television apparatus compares a display brightness which can be realized by the television apparatus with the upper limit display brightness 261 and determines whether or not the same display brightness as the upper limit display brightness 261 can be realized by the television apparatus. Subsequently, in a case where the same display brightness as the upper limit display brightness 261 cannot be realized by the television apparatus, the television apparatus compresses a range of the brightness of the output image file 104 and displays the image of the output image file 104 with the brightness of which the range has been compressed.

As described above, according to the present embodiment, processed image data and brightness information are associated with each other and recorded in a storage unit. Accordingly, display intended by the user can be performed as display of an image based on processed image data. Specifically, in a case of displaying an image based on processed image data, by taking brightness information based on the processed image data into consideration, display with same display brightness as the display brightness confirmed by the user in a case of generating the processed image data can be realized.

Moreover, the brightness of the graphic image data 259 can be variable and combining of the graphic image data 259 can be omitted. By combining the graphic image data 259, a brightness characteristic value (the average brightness 268) of image data may change and, in turn, an upper limit of display brightness, a range of display brightness, and the like may change. Specifically, in a case where the brightness of the graphic image data 259 is high, by combining the graphic image data 259, the average brightness 268 may increase, the upper limit of the display brightness may decrease, and a range of the display brightness may become narrow. The wider the range of the display brightness, the more favorable, and the higher the upper limit of the display brightness, the more favorable. For this reason, the graphic generating unit 211 favorably changes the brightness of the graphic image data 259 so that a change in the brightness characteristic value attributable to combining the graphic image data 259 is less than a threshold. Specifically, the graphic generating unit 211 favorably changes the brightness of the graphic image data 259 so that a difference between the brightness characteristic value of the linear image data 267 and the brightness characteristic value of the combined image data 260 is smaller than the threshold.

In addition, even when the brightness of the graphic image data 259 is changed, a change in the brightness characteristic value attributable to combining the graphic image data 259 may equal or exceed a threshold. In other words, even when the brightness of the graphic image data 259 is changed, a difference between the brightness characteristic value of the linear image data 267 and the brightness characteristic value of the combined image data 260 may equal or exceed the threshold. In such a case, even when the brightness of graphic image data is changed, the process of combining the graphic image data 259 is favorably omitted.

Furthermore, the graphic image data 259 is not combined onto image data to be recorded (processed image data; the post-metadata addition image data 269). Therefore, the BL controlling unit 212 favorably acquires a brightness characteristic value of the combined image data 260 in an image region other than the image region of the graphic image data 259 as the brightness characteristic value (the average brightness 268). Accordingly, changes in the upper limit of display brightness, a range of display brightness, and the like attributable to the combining of the graphic image data 259 can be suppressed.

Moreover, each of the thresholds described above may be a fixed value set by a manufacturer, a value that can be changed by the user, or a value automatically determined based on a use environment of the display apparatus or the like.

Moreover, the user may perform operations with respect to the image processing apparatus instead of operations with respect to the display apparatus. In addition, an instruction in accordance with a performed operation may be output from the image processing apparatus to the display apparatus. For example, an operation for selecting a loading type may be performed with respect to the image processing apparatus and the loading type information 262 in accordance with the performed operation may be notified from the image processing apparatus to the display apparatus. In a similar manner, the user may perform operations with respect to the display apparatus instead of operations with respect to the image processing apparatus. In addition, an instruction in accordance with a performed operation may be output from the display apparatus to the image processing apparatus.

### Second Embodiment

A second embodiment of the present invention will be described below. Hereinafter, points (configurations and processes) that differ from those of the first embodiment will be described in detail and descriptions of points that are the same as those of the first embodiment will be omitted.

The use of the brightness information 111 enables the brightness of the post-rendering image data 258 to be converted into same brightness as the display brightness (display brightness upon adjustment of a processing parameter) of the display apparatus 103. In the present embodiment, in the image processing apparatus 102, brightness converted image data 1011 (to be described later) is generated by converting the brightness of the post-rendering image data 258 to the same brightness as the display brightness of the display apparatus 103 based on the brightness information 111. In addition, the brightness converted image data 1011 is recorded in the image storage unit 201.

In the first embodiment, the post-metadata addition image data 269 is recorded in the image storage unit 201. In addition, the post-metadata addition image data 269 is read from the image storage unit 201 and the post-metadata addition image data 269 is displayed by the television apparatus. With such a configuration, in order to have the television apparatus display the post-metadata addition image data 269 with a same display brightness as the display brightness of the display apparatus 103, the television apparatus must generate the brightness converted image data 1011.

On the other hand, in the present embodiment, the brightness converted image data 1011 is generated and recorded by the image processing apparatus 102. Accordingly, a processing load on the television apparatus in a case of realizing display intended by the user can be reduced and display intended by the user can be realized with various apparatuses. Specifically, the television apparatus can acquire the brightness converted image data 1011 instead of the post-metadata addition image data 269 from the outside. In addition, by using the brightness converted image data 1011 acquired from the outside in place of the post-metadata addition image data 269, display with a display brightness intended by the user can be realized while omitting the generation of the brightness converted image data 1011. In addition, even with an apparatus (such as a simplified television apparatus or a mobile device) not equipped with a function of generating the brightness converted image data 1011, display with a display brightness intended by the user can be realized by simply acquiring the brightness converted image data 1011 from the outside and using the brightness converted image data 1011.

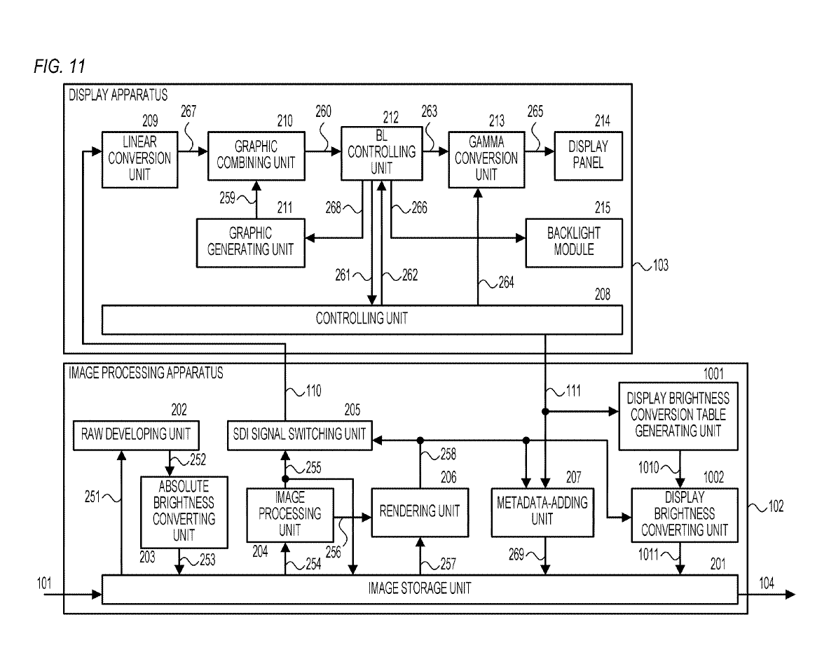

FIG. 11 is a diagram showing an example of a detailed configuration of the display system according to the present embodiment. In FIG. 11, same articles (apparatuses, functional units, data, and signals) as in the first embodiment (FIG. 2) are assigned same reference characters as in the first embodiment. As shown in FIG. 11, the image processing apparatus 102 according to the present embodiment further includes a display brightness conversion table generating unit 1001 and a display brightness converting unit 1002.

The display brightness conversion table generating unit 1001 acquires the brightness information 111. In addition, the display brightness conversion table generating unit 1001 generates a display brightness conversion table 1010 based on the brightness information 111 and outputs the display brightness conversion table 1010. The display brightness conversion table 1010 refers to a lookup table indicating a correspondence relationship between brightness (or a gradation value) of the post-rendering image data 258 and display brightness (display brightness upon adjustment of a processing parameter) of the display apparatus 103. A method of generating the display brightness conversion table 1010 is not particularly limited. A function indicating the correspondence relationship between the brightness of the post-rendering image data 258 and the display brightness of the display apparatus 103 may be determined instead of the display brightness conversion table 1010.

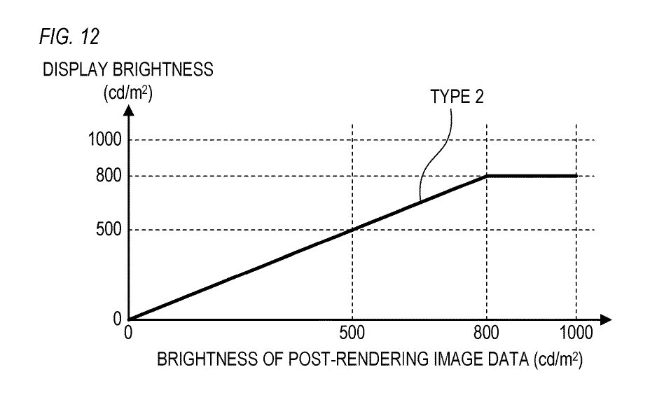

In the present embodiment, the display brightness conversion table generating unit 1001 extracts the upper limit display brightness 261 and the loading type information 262 from the brightness information 111. In addition, based on the extracted information, the display brightness conversion table generating unit 1001 determines conversion characteristics for converting the brightness of the post-rendering image data 258 into the display brightness of the display apparatus 103. For example, in a case where the upper limit display brightness 261 is 800 [cd/m²] and a loading type indicated by the loading type information 262 is the type 2, conversion characteristics shown in FIG. 12 are determined. A conversion lookup table of the conversion characteristics is output as the display brightness conversion table 1010. Subsequently, the display brightness conversion table generating unit 1001 generates the display brightness conversion table 1010 based on the determined conversion characteristics.

The display brightness converting unit 1002 converts the post-rendering image data 258 into the brightness converted image data 1011 using the display brightness conversion table 1010. In addition, the display brightness converting unit 1002 records the brightness converted image data 1011 in the image storage unit 201. A method of conversion from the post-rendering image data 258 to the brightness converted image data 1011 is not particularly limited.

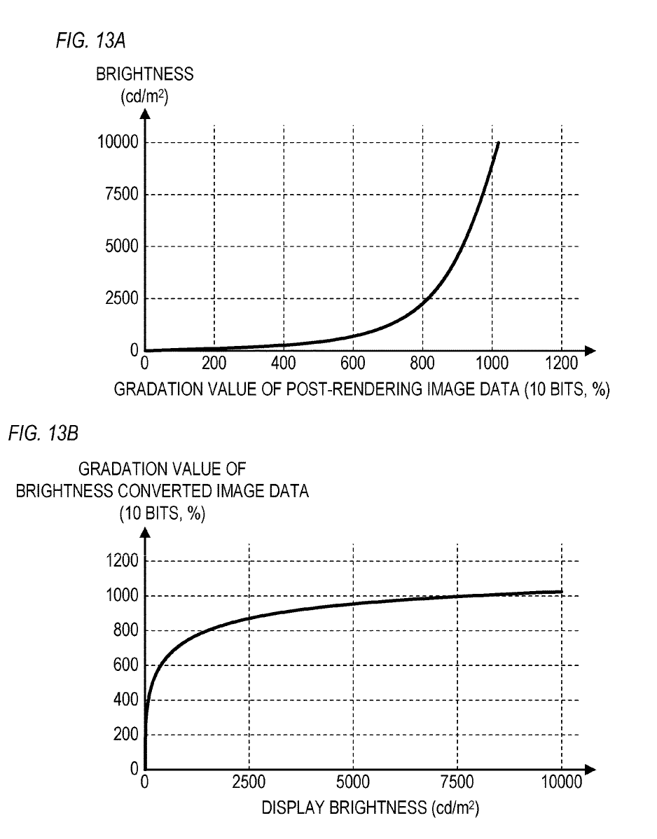

In the present embodiment, the display brightness converting unit 1002 converts the gradation value of the post-rendering image data 258 into physical brightness in accordance with the gradation characteristics of the post-rendering image data 258. Specifically, the display brightness converting unit 1002 converts the gradation value of the post-rendering image data 258 into physical brightness in accordance with the conversion characteristics shown in FIG. 13A. The conversion characteristics shown in FIG. 13A are reverse characteristics of the conversion characteristics shown in FIG. 4 and are conversion characteristics in conformity with the ST2084 standard.

In addition, the display brightness converting unit 1002 converts the brightness of the post-rendering image data 258 into the display brightness in accordance with the correspondence relationship indicated by the display brightness conversion table 1010. Subsequently, the display brightness converting unit 1002 converts the obtained display brightness into a gradation value so that the brightness converted image data 1011 with the same gradation characteristics as the gradation characteristics of the post-rendering image data 258 is obtained. Specifically, the display brightness converting unit 1002 converts the obtained display brightness (brightness of the brightness converted image data 1011) into a gradation value (a gradation value of the brightness converted image data 1011) in accordance with the conversion characteristics shown in FIG. 13B. The conversion characteristics shown in FIG. 13B are conversion characteristics in conformity with the ST2084 standard.

As described above, according to the present embodiment, brightness converted image data is generated and recorded by the image processing apparatus. Accordingly, display intended by the user can be realized with various apparatuses and a processing load on an apparatus in a case of realizing display intended by the user can be reduced. Moreover, while the post-metadata addition image data 269 is also recorded in the image storage unit 201 in the example shown in FIG. 11, recording of the post-metadata addition image data 269 may be omitted.

### Third Embodiment

A third embodiment of the present invention will be described below. Hereinafter, points (configurations and processes) that differ from those of the first and second embodiments will be described in detail and descriptions of points that are the same as those of the first and second embodiments will be omitted. In the second embodiment, an example in which the brightness converted image data 1011 is generated and recorded by the image processing apparatus 102 has been described. In the present embodiment, the brightness converted image data 1011 is generated by the display apparatus 103. Accordingly, a processing load on the image processing apparatus 102 can be reduced.

In the second embodiment, since the rendering process performed by the rendering unit 206 of the image processing apparatus 102 is image processing with respect to all frames of the moving image data, a processing load due to the rendering process is high. In addition, since the process (conversion process) performed by the display brightness converting unit 1002 of the image processing apparatus 102 is image processing with respect to all frames of the moving image data, a processing load due to the conversion process is high. Furthermore, the rendering process by the rendering unit 206 and the conversion process by the display brightness converting unit 1002 are performed in parallel. Therefore, an apparatus which performs the rendering process and an apparatus which performs the conversion process described above favorably differ from one another.

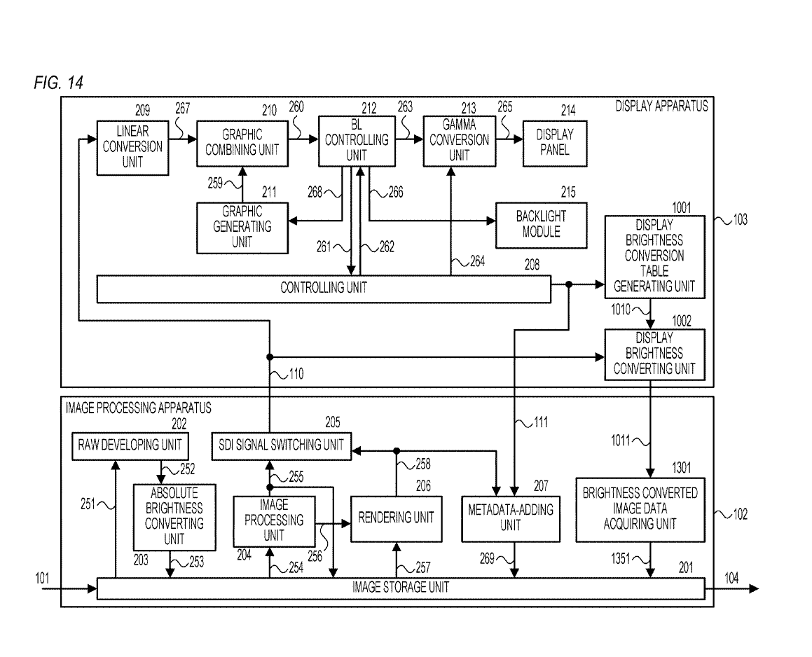

FIG. 14 is a diagram showing an example of a detailed configuration of the display system according to the present embodiment. In FIG. 14, same articles (apparatuses, functional units, data, and signals) as in the second embodiment (FIG. 11) are assigned same reference characters as in the second embodiment. As shown in FIG. 14, in the present embodiment, the display brightness conversion table generating unit 1001 and the display brightness converting unit 1002 are provided in the display apparatus 103. In addition, the image processing apparatus 102 according to the present embodiment further includes a brightness converted image data acquiring unit 1301.

In the present embodiment, the display brightness conversion table generating unit 1001 and the display brightness converting unit 1002 perform similar processes as in the second embodiment. The display brightness converting unit 1002 according to the present embodiment extracts the post-rendering image data 258 from the SDI signal 110. In addition, the display brightness converting unit 1002 according to the present embodiment outputs the brightness converted image data 1011 to the image processing apparatus 102. For example, the display brightness converting unit 1002 performs SDI transmission of the brightness converted image data 1011 to the image processing apparatus 102.

The brightness converted image data acquiring unit 1301 acquires the brightness converted image data 1011 from the display apparatus 103 (the display brightness converting unit 1002) and records the brightness converted image data 1011 in the image storage unit 201. For example, the brightness converted image data acquiring unit 1301 acquires an SDI signal output from the display brightness converting unit 1002 and extracts the brightness converted image data 1011 from the acquired SDI signal. In addition, the brightness converted image data acquiring unit 1301 records extracted data 1351 that is the extracted brightness converted image data 1011 in the image storage unit 201.

As described above, according to the present embodiment, brightness converted image data is generated and recorded by the display apparatus. Accordingly, in addition to producing a similar effect to the second embodiment, a processing load on the image processing apparatus can also be reduced.

### Fourth Embodiment

A fourth embodiment of the present invention will be described below. In the present embodiment, an image processing apparatus will be described which acquires the post-metadata addition image data recorded in the first to third embodiments and which performs image processing using the acquired post-metadata addition image data. Moreover, while an example in which an image processing apparatus according to the present embodiment is a display apparatus will be hereinafter described, the image processing apparatus according to the present embodiment may be a separate apparatus from a display apparatus.

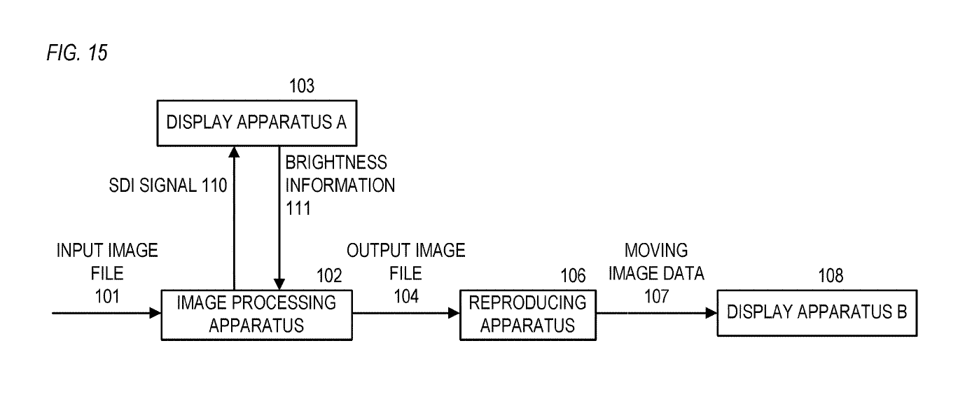

FIG. 15 is a diagram showing an example of a configuration of a display system (an image processing system) according to the present embodiment. In FIG. 15, same articles (apparatuses, functional units, data, and signals) as in the first to third embodiments are assigned same reference characters as in the first to third embodiments. As shown in FIG. 15, the display system according to the present embodiment includes the image processing apparatus 102, a display apparatus A 109, a reproducing apparatus 106, and a display apparatus B 108. The display apparatus A 109 is the same as the display apparatus 103 according to the first to third embodiments. The reproducing apparatus 106 acquires the output image file 104 from the image processing apparatus 102 (the image storage unit 201), converts the acquired output image file 104 into moving image data 107, and outputs the moving image data 107 to the display apparatus B 108. In the present embodiment, image data of each frame of the moving image data 107 is the post-metadata addition image data according to the first to third embodiments.

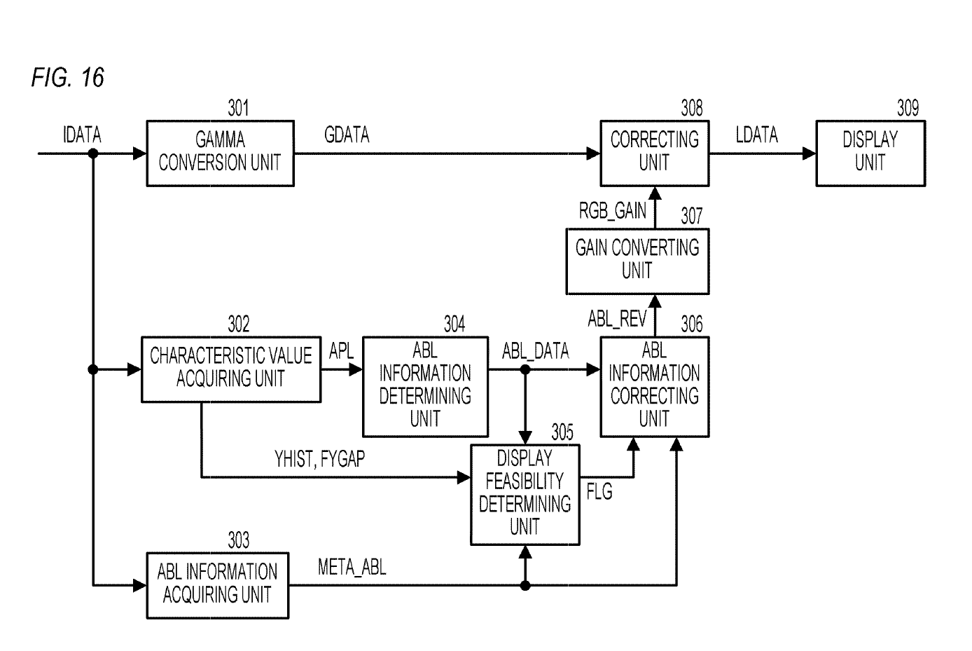

FIG. 16 is a diagram showing an example of a configuration of the display apparatus B 108.

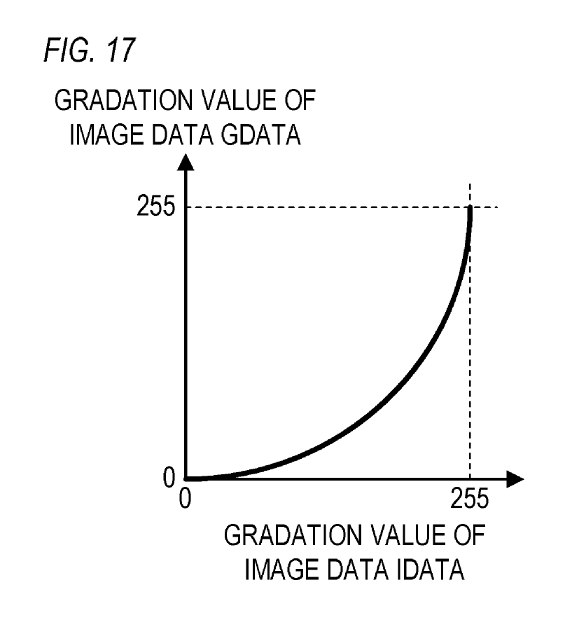

A gamma conversion unit 301 acquires the moving image data 107. For each frame of the moving image data 107, the gamma conversion unit 301 applies a gamma conversion process to image data IDATA of the frame to generate image data GDATA. Subsequently, the gamma conversion unit 301 outputs the image data GDATA of each frame to a correcting unit 308. The gamma conversion process refers to, for example, a process of converting a gradation value using a one-dimensional lookup table indicating a correspondence relationship between a gradation value before conversion and a gradation value after the conversion. The one-dimensional lookup table is prepared in advance. FIG. 17 shows an example of a correspondence relationship between a gradation value of the image data IDATA and a gradation value of the image data GDATA. While an example of a case where a gradation value is an 8-bit value (0 to 255) will be described in the present embodiment, the number of bits used for a gradation value may be more or less than eight. For example, a 10-bit gradation value, a 12-bit gradation value, or the like may be used.

A characteristic value acquiring unit 302 acquires, for each frame of the moving image data 107, a brightness characteristic value of the image data IDATA from the image data IDATA. In the present embodiment, for each frame, three types of brightness characteristic value s including a brightness histogram YHIST, a frame difference histogram FYGAP, and an average brightness APL are acquired. Moreover, the types of brightness characteristic values and the number of types of brightness characteristic values are not particularly limited.

In the present embodiment, the characteristic value acquiring unit 302 acquires (calculates) a brightness characteristic value using a brightness value Yd of each pixel of the image data IDATA. For example, in a case where a pixel value of the image data IDATA is a YCbCr value (a pixel value in a YCbCr color space), a Y value included in the YCbCr value is used as the brightness value Yd. In a case where a pixel value of the image data IDATA is an RGB value (a pixel value in an RGB color space), the RGB value is converted into the brightness value Yd. For example, the brightness value Yd is calculated from an RGB value (an R value Rd, a G value Gd, and a B value Bd) using Expression 1 below.

Yd=0.2×Rd+0.7×Gd+0.1×Bd (Expression 1)

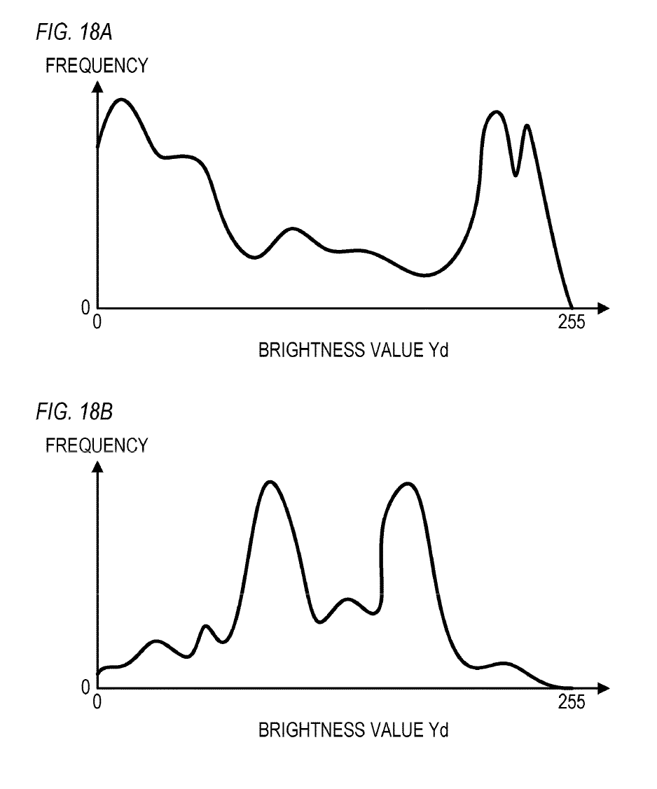

The brightness histogram YHIST is histogram data indicating a frequency of each brightness value Yd. The “frequency of the brightness value Yd” refers to “the number of pixels having the brightness value Yd among a plurality of pixels of the image data IDATA”. FIGS. 18A and 18B show examples of the brightness histogram YHIST. FIG. 18A shows an example of a case where the image data IDATA contains large numbers of pixels with high brightness and pixels with low brightness. FIG. 18B shows an example of a case where the image data IDATA contains a large number of pixels with intermediate brightness.

The frame difference histogram FYGAP is a histogram of a brightness difference from another frame (a frame which differs from a processing target frame). In the present embodiment, a frame preceding the processing target frame is used as the other frame described above. Alternatively, the other frame described above may be a frame preceding the processing target frame by two or more frames.

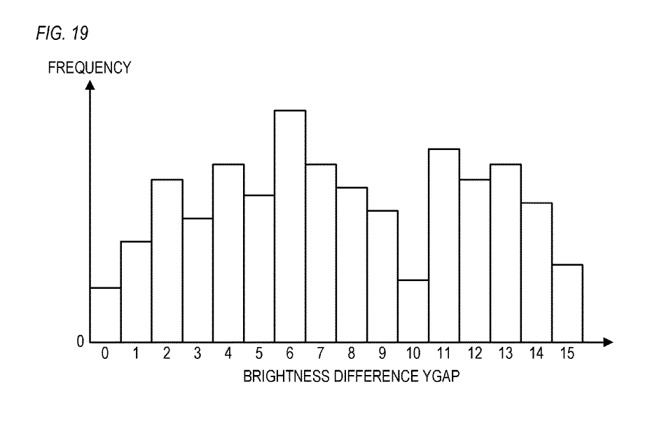

Specifically, the frame difference histogram FYGAP is histogram data indicating a frequency of a difference (a brightness difference YGAP) between the brightness value Yd of a current frame (the processing target frame) and the brightness value Yd of a previous frame (a frame preceding the processing target frame). The “frequency of the brightness difference YGAP” refers to “the number of pixels corresponding to the brightness difference YGAP among a plurality of pixels of the image data IDATA”. FIG. 19 shows an example of the frame difference histogram FYGAP. FIG. 19 shows an example of a case where an entire image has movement (a movement of an image).

An example of a method of acquiring the frame difference histogram FYGAP will now be described. First, for each pixel of the image data IDATA, the characteristic value acquiring unit 302 calculates the brightness difference YGAP. The brightness difference YGAP is calculated using Expression 2 below. In Expression 2, “ABS( )” denotes a function which returns an absolute value of an argument (a value described within ( )). In addition, “Yd (N)” denotes the brightness value Yd of a current frame and “Yd (N−1)” denotes the brightness value Yd of a preceding frame.

YGAP=ABS(Yd(N)−Yd(N−1))/16 (Expression 2)

In Expression 2, ABS (Yd (N)−Yd (N−1)) is divided by 16 in order to reduce a data size of the frame difference histogram FYGAP by a factor of 1/16. By dividing ABS (Yd (N)−Yd (N−1)) by 16, a 4-bit value (0 to 15) is obtained as the brightness difference YGAP. Alternatively, ABS(Yd(N)−Yd (N−1)) may be calculated as the brightness difference YGAP. In this case, a 16-bit value (0 to 255) is obtained as the brightness difference YGAP.

Subsequently, for each brightness difference YGAP, the characteristic value acquiring unit 302 counts the number of pixels corresponding to the brightness difference YGAP. Accordingly, the frame difference histogram FYGAP such as that shown in FIG. 19 is obtained.

The average brightness APL represents an average value of the brightness values Yd of an entire image. For example, the average brightness APL is calculated using Expression 3 below. In Expression 3, “h” denotes the number of pixels of the image data IDATA in a horizontal direction and “v” denotes the number of pixels of the image data IDATA in a vertical direction. In addition, “Yd(M)” denotes the brightness value Yd of an M-th pixel. In Expression 3, normalization for converting a range of the average brightness APL into a range of 0 to 100 is performed.

$$\begin{matrix}[ Math . 1 ] & \\ APL = ( ( \frac{{\sum }_{M = 1}^{h \times v} Y ( M )}{h \times v} ) / 255 ) \times 100 & ( Expression 3 )\end{matrix}$$

The characteristic value acquiring unit 302 outputs the average brightness APL to an ABL information determining unit 304 and outputs the brightness histogram YHIST and the frame difference histogram FYGAP to a display feasibility determining unit 305.

The ABL information acquiring unit 303 acquires the brightness information 111 for each frame of the moving image data 107. Specifically, for each frame, the ABL information acquiring unit 303 extracts the brightness information 111 from metadata of the image data IDATA. The brightness information 111 is information related to a first correspondence relationship which is the correspondence relationship between the display brightness of the display apparatus A 109 and the brightness of the image data IDATA.

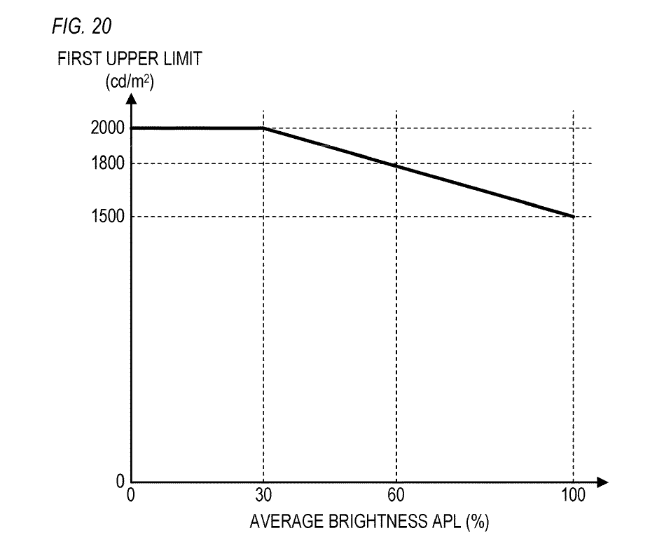

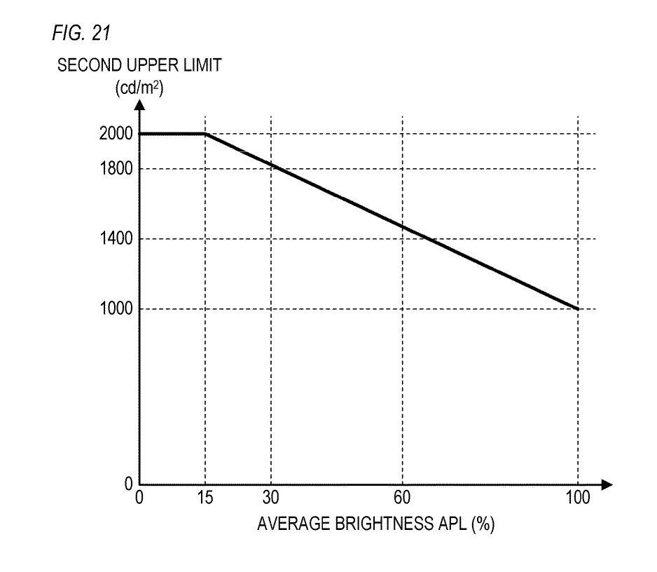

An example of ABL characteristics of the display apparatus A 109 is shown in FIG. 20. The ABL characteristics of the display apparatus A 109 are characteristics of a correspondence relationship between a range of the display brightness of the display apparatus A 109 and the brightness characteristic value of the image data IDATA. In the present embodiment, the ABL characteristics of the display apparatus A 109 are characteristics of a correspondence relationship between a first upper limit (an upper limit of the display brightness of the display apparatus A 109) and the average brightness APL (a brightness characteristic value such that the higher the brightness of the image data IDATA, the larger the brightness characteristic value). The ABL characteristics are determined based on power consumption of the display apparatus, element performance of the display apparatus, and the like. In FIG. 20, in a range of the average brightness APL of no more than a first threshold (no more than 30%), the first upper limit is constant (2000 [cd/m²]). In addition, in a range of the average brightness APL of at least the first threshold (at least 30%), the first upper limit decreases with respect to an increase in the average brightness APL. Specifically, with respect to an increase in the average brightness APL from 30% to 100%, the first upper limit declines linearly from 2000 [cd/m²] to 1500 [cd/m²]. In the present embodiment, as the brightness information 111, ABL information META_ABL indicating the first upper limit corresponding to the average brightness ARL of the image data IDATA is acquired.

Moreover, while it is assumed that the ABL information META_ABL is added to each frame, one piece of ABL information META_ABL may be added to one scene constituted by a plurality of frames. In addition, the ABL information META_ABL added to the scene may be used as the ABL information META_ABL corresponding to each frame of the scene.

Furthermore, the ABL information META_ABL may include temporal information. For example, information indicating how much the first upper limit varies during a predetermined period including a frame (a corresponding frame) which corresponds to the ABL information META_ABL may be included in the ABL information META_ABL. The predetermined period is a period from a frame preceding the corresponding frame by 30 frames to a frame following the corresponding frame by 30 frames. Specifically, in a case where the first upper limit varies by exactly 10% during the predetermined period, information such as “variation amount=10%” may be included in the ABL information META_ABL.

For each frame of the moving image data 107, the ABL information determining unit 304 determines a second correspondence relationship based on the brightness characteristic value acquired by the characteristic value acquiring unit 302. The second correspondence relationship refers to a correspondence relationship between the display brightness of the display apparatus B 108 and the brightness of the image data IDATA. In the present embodiment, the ABL information determining unit 304 determines the second correspondence relationship from the average brightness APL.

In the present embodiment, information on the ABL characteristics of the display apparatus B 108 is recorded in advance in a ROM (not shown). An example of ABL characteristics of the display apparatus B 108 is shown in FIG. 21. The ABL characteristics of the display apparatus B 108 are characteristics of a correspondence relationship between a second upper limit (an upper limit of the display brightness of the display apparatus B 108) and the average brightness APL (a brightness characteristic value such that the higher the brightness of the image data IDATA, the larger the brightness characteristic value).

In FIG. 21, in a range of the average brightness APL of no more than a second threshold (no more than 15%), the second upper limit is constant (2000 [cd/m²]). Therefore, the display apparatus B 108 is capable of displaying an image based on image data IDATA of which the average brightness APL is no more than 15% with a same display brightness as the display brightness of the display apparatus A 109.

In addition, in FIG. 21, in a range of the average brightness APL of at least the second threshold (at least 15%), the second upper limit decreases with respect to an increase in the average brightness APL. Specifically, with respect to an increase in the average brightness APL from 15% to 100%, the second upper limit declines linearly from 2000 [cd/m²] to 1000 [cd/m²]. Therefore, the display apparatus B 108 is not capable of displaying an image based on image data IDATA of which the average brightness APL is more than 15% with the same display brightness as the display brightness of the display apparatus A 109. The display apparatus B 108 is only capable of displaying an image based on image data IDATA of which the average brightness APL is more than 15% with a lower display brightness than the display brightness of the display apparatus A 109.

In the present embodiment, the ABL information determining unit 304 reads the second upper limit corresponding to the average brightness APL of the image data IDATA from information on the ABL characteristics of the display apparatus B 108 and generates ABL information ABL_DATA indicating the read second upper limit.

The display feasibility determining unit 305 determines, for each frame of the moving image data 107, whether or not the display apparatus B 108 is capable of displaying an image based on the image data IDATA with a same display brightness as the display brightness of the display apparatus A 109 (a display feasibility determination process). The display feasibility determination process is performed based on the brightness information 111 acquired by the ABL information acquiring unit 303 and on the second correspondence relationship determined by the ABL information determining unit 304. Specifically, the display feasibility determining unit 305 performs the display feasibility determination process based on the ABL information META_ABL from the ABL information acquiring unit 303 and the ABL information ABL_DATA from the ABL information determining unit 304.

In addition, the display feasibility determining unit 305 detects, based on a brightness characteristic value acquired by the characteristic value acquiring unit 302, a brightness change scene that is a scene (a scene of the moving image data 107) in which a change (a variation) in the brightness of the image data IDATA between frames is larger than a third threshold. Specifically, for each frame of the moving image data 107, the display feasibility determining unit 305 acquires the brightness histogram YHIST and the frame difference histogram FYGAP from the characteristic value acquiring unit 302. In addition, for each frame, based on the brightness histogram YHIST and the frame difference histogram. FYGAP, the display feasibility determining unit 305 determines whether or not the frame is a frame of a brightness change scene (a brightness change scene determination process).

Furthermore, for each frame of the moving image data 107, the display feasibility determining unit 305 outputs a determination result value FLG based on a determination result of the display feasibility determination process and a determination result of the brightness change scene determination process (a detection result of a process of detecting a brightness change scene).

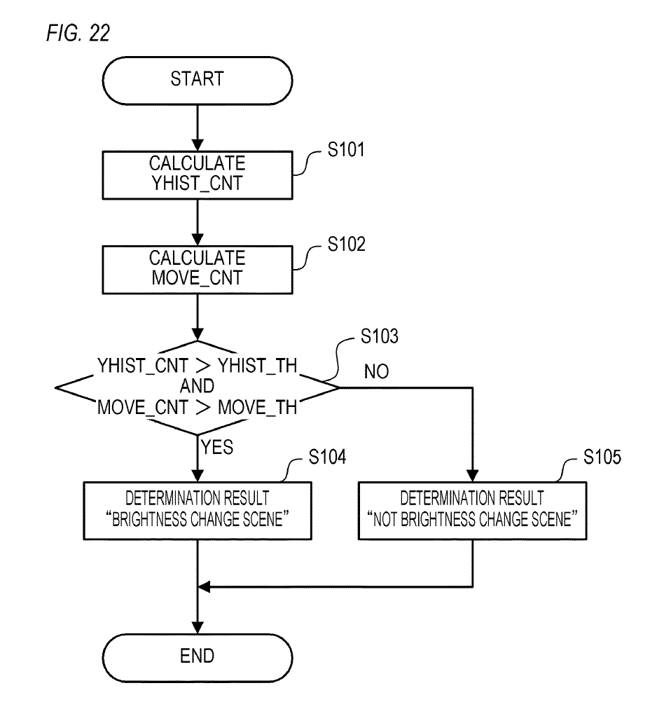

A specific example of the brightness change scene determination process will be described with reference to FIG. 22. FIG. 22 is a flow chart showing an example of the brightness change scene determination process.

First, in S101, the display feasibility determining unit 305 calculates a sum of frequencies (frequencies of the brightness histogram YHIST) corresponding to brightness values Yb that are larger than a threshold GRAD_TH as a frequency YHIST_CNT. The threshold GRAD_TH is a brightness value Yb corresponding to a fourth threshold representing brightness. For example, the brightness value Yb of intermediate brightness, the brightness value Yb of high brightness, or the like is used as the threshold GRAD_TH. In the present embodiment, the threshold GRAD_TH=250 is used. In the brightness histogram YHIST shown in FIG. 18A, more frequencies correspond to brightness values Yb of at least the threshold GRAD_TH=250 than in the brightness histogram YHIST shown in FIG. 18B. Therefore, in a case where the brightness histogram YHIST shown in FIG. 18A is used, a larger value is calculated as the frequency YHIST_CNT than a case of using the brightness histogram YHIST shown in FIG. 18B.

Next, in S102, the display feasibility determining unit 305 calculates a sum of frequencies (frequencies of the frame difference histogram FYGAP) corresponding to brightness differences YGAP that are larger than a threshold DIFF_TH as a frequency MOVE_CNT. The threshold DIFF_TH is a threshold for determining a presence or absence of movement of an image. A “pixel corresponding to the brightness difference YGAP that is larger than the threshold DIFF_TH” signifies “a pixel with a movement of the image” and “a pixel corresponding to the brightness difference YGAP of no more than the threshold DIFF_TH” signifies “a pixel without a movement of the image”.

Subsequently, in S103, the display feasibility determining unit 305 compares the frequency YHIST_CNT with a threshold (a fifth threshold) YHIST_TH and compares the frequency MOVE_CNT with a threshold (a sixth threshold) MOVE_TH. Specifically, the display feasibility determining unit 305 determines whether or not conditions described below are satisfied. The process is advanced to S104 in a case where the following conditions are satisfied, but the process is advanced to S105 in a case where the following conditions are not satisfied.

YHIST_CNT>YHIST_TH, and

MOVE_CNT>MOVE_TH Conditions:

In S104, the display feasibility determining unit 305 determines that “the processing target frame is a frame of a brightness change scene”. In S105, the display feasibility determining unit 305 determines that “the processing target frame is not a frame of a brightness change scene”.

The “frequency YHIST_CNT” can be rephrased as “a size of an image region with higher brightness than the fourth threshold”. In addition, “the frequency MOVE_CNT” can be rephrased as “a size of an image region with a movement of the image”. According to the method described above, a scene of which a size of an image region of which brightness is higher than the fourth threshold is larger than the fifth threshold and of which a size of an image region with a movement of an image is larger than the sixth threshold is detected as a brightness change scene.

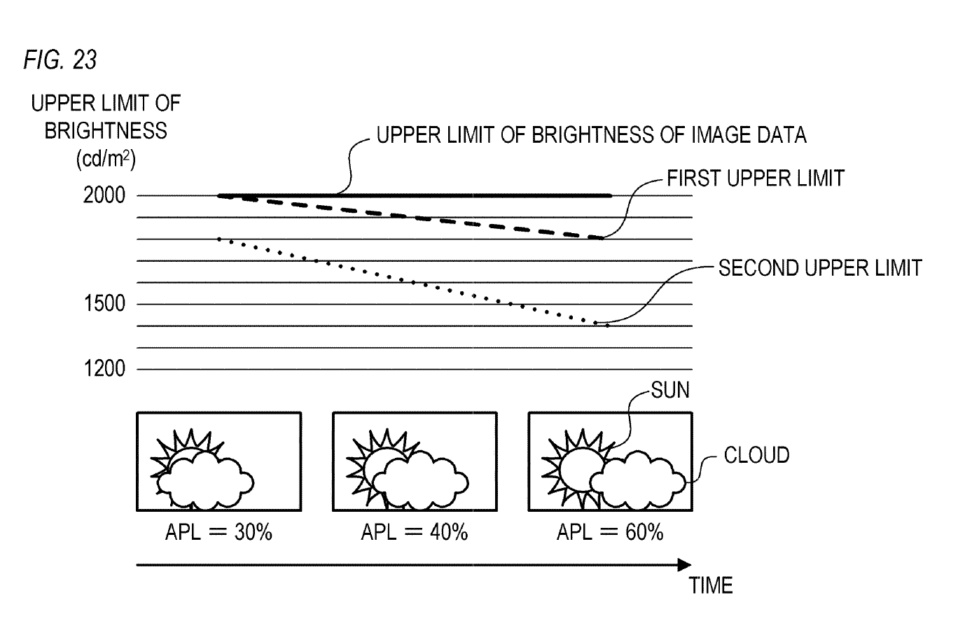

FIG. 23 shows an example of a brightness change scene. The scene shown in FIG. 23 portrays the sun (brightness 2000 [cd/m²]) appearing from behind a cloud. In the scene shown in FIG. 23, with the passage of time, a ratio of the sun in an entire image increases and the average brightness APL increases. An upper limit of the brightness of the image data IDATA is brightness 2000 [cd/m²]. However, the display apparatus A 109 has the ABL characteristics shown in FIG. 20. Therefore, in the scene shown in FIG. 23, the first upper limit (the upper limit of the display brightness of the display apparatus A 109) varies between 1800 [cd/m²] and 2000 [cd/m²]. In other words, the first upper limit changes with a change amount of 200 [cd/m²]. In addition, the display apparatus B 108 has the ABL characteristics shown in FIG. 21. Therefore, in the scene shown in FIG. 23, the second upper limit (the upper limit of the display brightness of the display apparatus B 108) varies between 1400 [cd/m²] and 1800 [cd/m²]. In other words, the second upper limit changes with a change amount of 400 [cd/m²].

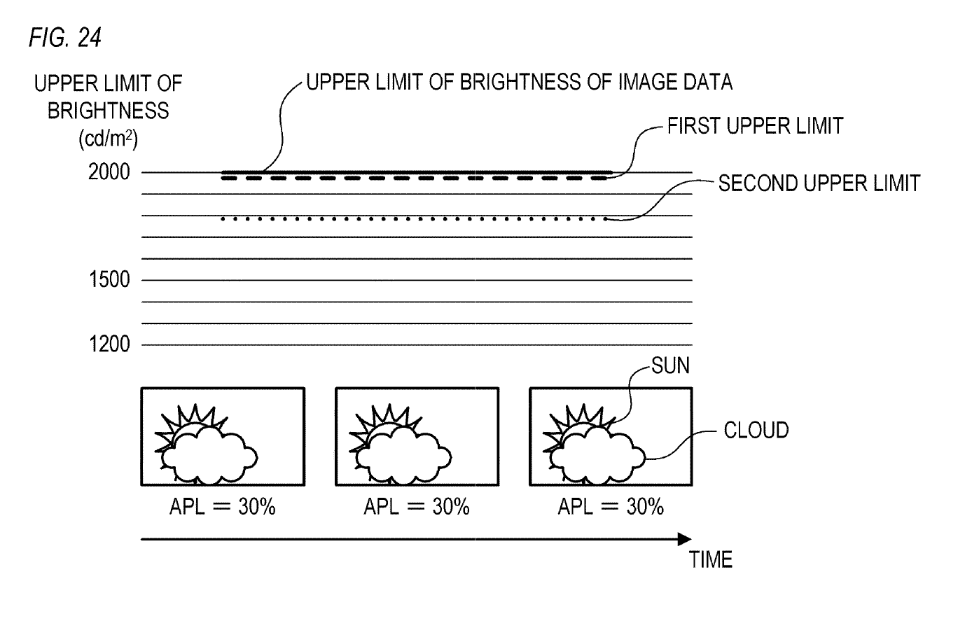

FIG. 24 shows an example of a scene that is not a brightness change scene. The scene shown in FIG. 24 also portrays a cloud and the sun. However, in the scene shown in FIG. 24, a relative positional relationship between the cloud and the sun does not change over time. Therefore, there is no time change in the ratio of the sun in the entire image and there is no time change in the average brightness APL. As a result, neither a time change in the first upper limit nor a time change in the second upper limit occurs.

Moreover, a method of the brightness change scene determination process is not limited to the method described above. For example, the average brightness APL may be used in place of the brightness histogram YHIST and the frame difference histogram FYGAP. Specifically, a scene with a large change in the average brightness APL between frames may be detected as a brightness change scene. Alternatively, a brightness change scene may be detected using the brightness information 111 (the ABL information META-ABL) in place of the brightness characteristic value acquired by the characteristic value acquiring unit 302. A brightness change scene may be detected using both a brightness characteristic value and the brightness information 111.

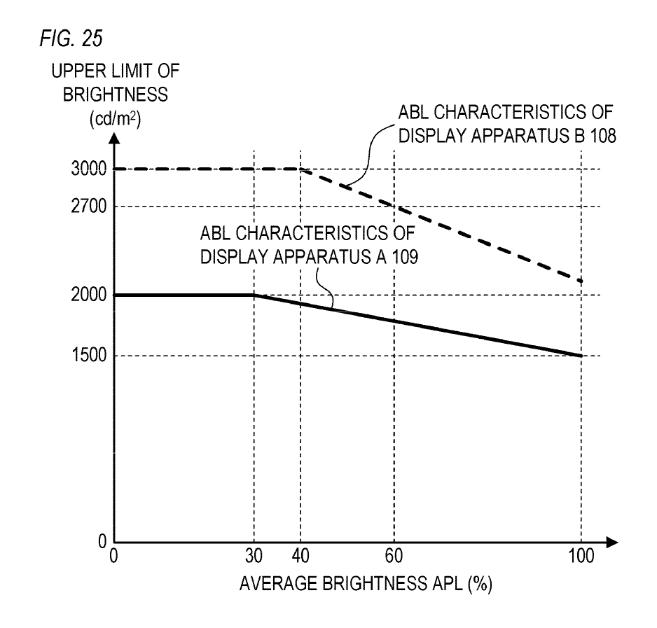

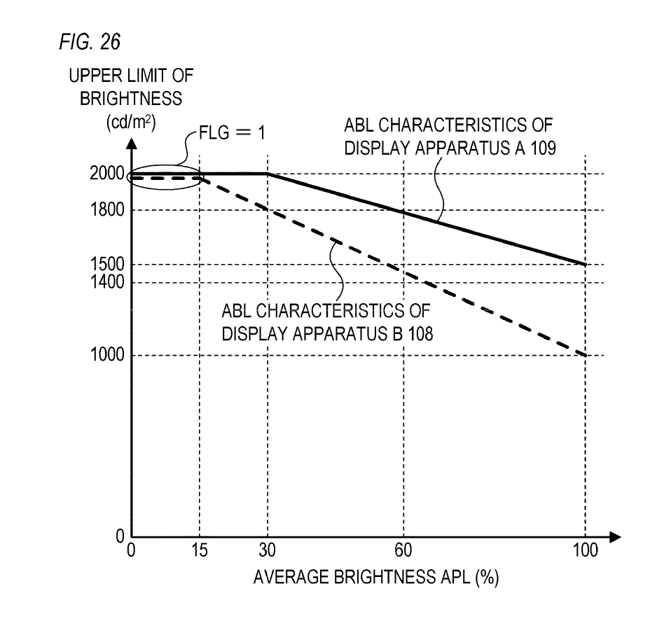

Specific examples of the display feasibility determination process will be described with reference to FIGS. 25 and 26. FIGS. 25 and 26 show examples of ABL characteristics of the display apparatus A 109 and ABL characteristics of the display apparatus B 108. In the display feasibility determination process, the display feasibility determining unit 305 compares the ABL information META_ABL and the ABL information ABL_DATA from the ABL information determining unit 304 with each other.

A case where the second upper limit indicated by the ABL information ABL_DATA is higher than the first upper limit indicated by the ABL information META_ABL will now be considered. In this case, by reducing the second upper limit to a same display brightness as the first upper limit indicated by the ABL information META_ABL, the display apparatus B 108 can realize display with the same display brightness as the display brightness of the display apparatus A 109.

A case where the second upper limit indicated by the ABL information ABL_DATA is equal to the first upper limit indicated by the ABL information META_ABL will now be considered. In this case, by using the second upper limit indicated by the ABL information ABL_DATA, the display apparatus B 108 can realize display with the same display brightness as the display brightness of the display apparatus A 109.

A case where the second upper limit indicated by the ABL information ABL_DATA is lower than the first upper limit indicated by the ABL information META_ABL will now be considered. In this case, the display apparatus B 108 cannot use a same display brightness as the first upper limit indicated by the ABL information META_ABL as the second upper limit. Therefore, the display apparatus B 108 is not capable of realizing display with the same display brightness as the display brightness of the display apparatus A 109.

Therefore, in a case where the second upper limit of the ABL information ABL_DATA is at least the first upper limit of the ABL information META_ABL, the display feasibility determining unit 305 determines that “the display apparatus B 108 is capable of realizing display with the same display brightness as the display brightness of the display apparatus A 109”. In addition, in a case where the second upper limit of the ABL information ABL_DATA is at least the first upper limit of the ABL information META_ABL, the display feasibility determining unit 305 outputs a determination result value FLG=0. The determination result value FLG=0 corresponds to a determination result of “the display apparatus B 108 is capable of realizing display with the same display brightness as the display brightness of the display apparatus A 109”.

In addition, in a case where the second upper limit of the ABL information ABL_DATA is lower than the first upper limit of the ABL information META_ABL, the display feasibility determining unit 305 determines that “the display apparatus B 108 is incapable of realizing display with the same display brightness as the display brightness of the display apparatus A 109”. Furthermore, in a case where the second upper limit of the ABL information ABL_DATA is lower than the first upper limit of the ABL information META_ABL, the display feasibility determining unit 305 outputs a determination result value FLG≠0. The determination result value FLG≠0 corresponds to a determination result of “the display apparatus B 108 is incapable of realizing display with the same display brightness as the display brightness of the display apparatus A 109”.

In a case where the ABL characteristics of the display apparatus A 109 and the ABL characteristics of the display apparatus B 108 are the characteristics shown in FIG. 25, a higher display brightness than the first upper limit of the ABL information META_ABL is obtained as the second upper limit of the ABL information ABL_DATA. Therefore, in a case where the ABL characteristics of the display apparatus A 109 and the ABL characteristics of the display apparatus B 108 are the characteristics shown in FIG. 25, a determination result of “the display apparatus B 108 is capable of realizing display with the same display brightness as the display brightness of the display apparatus A 109” is obtained. In addition, the determination result value FLG=0 is output.

On the other hand, in a case where the ABL characteristics of the display apparatus A 109 and the ABL characteristics of the display apparatus B 108 are the characteristics shown in FIG. 26, a display brightness lower than the first upper limit of the ABL information META_ABL is obtained as the second upper limit of the ABL information ABL_DATA. Therefore, in a case where the ABL characteristics of the display apparatus A 109 and the ABL characteristics of the display apparatus B 108 are the characteristics shown in FIG. 26, a determination result of “the display apparatus B 108 is incapable of realizing display with the same display brightness as the display brightness of the display apparatus A 109” may be obtained. In addition, the determination result value FLG≠0 may be output.

In the present embodiment, in a case where the second upper limit of the ABL information ABL_DATA is lower than the first upper limit of the ABL information META_ABL, the display feasibility determining unit 305 determines a value of the determination result value FLG by further taking the result of the brightness change scene determination process into consideration. Specifically, in a case where the second upper limit of the ABL information ABL_DATA is lower than the first upper limit of the ABL information META_ABL and the processing target frame is not a frame of a brightness change scene, the display feasibility determining unit 305 outputs a determination result value FLG=1. In addition, in a case where the second upper limit of the ABL information ABL_DATA is lower than the first upper limit of the ABL information META_ABL and the processing target frame is a frame of a brightness change scene, the display feasibility determining unit 305 outputs a determination result value FLG=2. For example, the determination result value FLG=1 is output in a case where a change in the average brightness APL between frames is a change in the average brightness APL corresponding to a range shown circled in FIG. 26.

The determination result value FLG=1 corresponds to a determination result of “the display apparatus B 108 is incapable of realizing display with the same display brightness as the display brightness of the display apparatus A 109” and a determination result of “the processing target frame is not a frame of a brightness change scene”. The determination result value FLG=2 corresponds to a determination result of “the display apparatus B 108 is incapable of realizing display with the same display brightness as the display brightness of the display apparatus A 109” and a determination result of “the processing target frame is a frame of a brightness change scene”.

An ABL information correcting unit 306 corrects, for each frame of the moving image data 107, the second correspondence relationship based on the determination result value FLG from the display feasibility determining unit 305 (and the ABL information META_ABL from the ABL information acquiring unit 303). In the present embodiment, the second correspondence relationship is corrected so that a manner of change in the second correspondence relationship between frames approaches a manner of change in the first correspondence relationship between the frames. Specifically, the second correspondence relationship is corrected so that a manner of change in the second upper limit with respect to a change in the brightness characteristic value (the average brightness APL) approaches a manner of change in the first upper limit with respect to a change in the brightness characteristic value. In the present embodiment, the second correspondence relationship is corrected so as to change a variation start point (a combination of the second threshold (“15%” in FIG. 21) and the second upper limit corresponding to the second threshold) of the ABL characteristics of the display apparatus B 108. In the present embodiment, as a process of correcting the second correspondence relationship, a process of correcting the ABL information ABL_DATA from the ABL information determining unit 304 is performed. Subsequently, the ABL information correcting unit 306 outputs ABL information ABL_REV after the correction to a gain converting unit 307.

A case where the determination result value FLG=0 will now be described. As described earlier, in a case where the determination result value FLG=0, the display apparatus B 108 is capable of realizing display with the same display brightness as the display brightness of the display apparatus A 109. Therefore, the ABL information correcting unit 306 corrects the second correspondence relationship so that the second correspondence relationship approximately matches the first correspondence relationship (“an approximate match” includes “a complete match”). Specifically, the ABL information correcting unit 306 corrects the ABL information ABL_DATA (second upper limit) so that the ABL information ABL_DATA approximately matches the ABL information META_ABL (first upper limit).

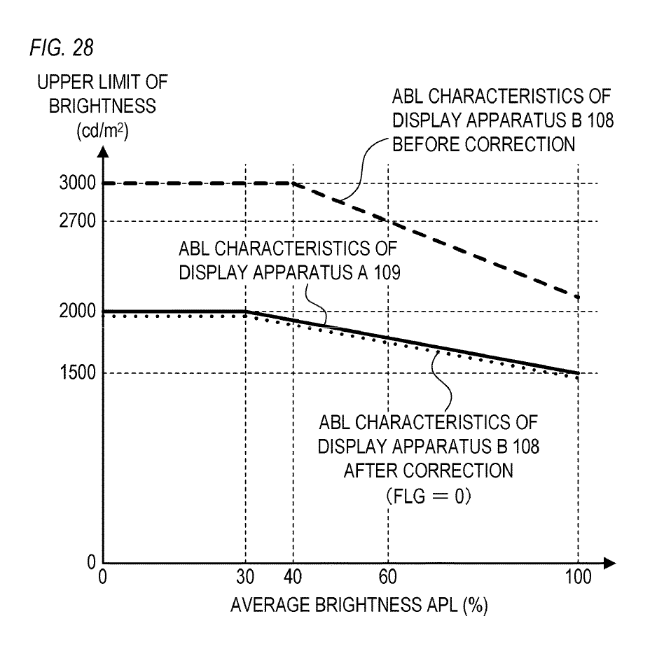

A case will now be considered where the ABL characteristics of the display apparatus A 109 are the characteristics depicted by a thick solid line in FIG. 28, the ABL characteristics of the display apparatus B 108 before correction are the characteristics depicted by a thick dashed line in FIG. 28, and the determination result value FLG is “0”. In this case, for example, the ABL information ABL_DATA is corrected so that the characteristics depicted by a dotted line in FIG. 28 are obtained as the ABL characteristics of the display apparatus B 108 after the correction. In FIG. 28, the ABL characteristics of the display apparatus B 108 after the correction matches the ABL characteristics of the display apparatus A 109.

A case where the determination result value FLG=1 will now be described. As described earlier, the determination result value FLG=1 corresponds to a determination result of “the display apparatus B 108 is incapable of realizing display with the same display brightness as the display brightness of the display apparatus A 109” and a determination result of “the processing target frame is not a frame of a brightness change scene”. In a scene that is not a brightness change scene, since a change in the brightness of the image data IDATA between frames is small, a difference in the manner of change in the second correspondence relationship between frames and the manner of change in the first correspondence relationship between frames is small. In addition, in a scene that is not a brightness change scene, flicker of the second upper limit, flicker of the display brightness of the display apparatus B 108, and the like may not occur or may only occur in small amounts. Therefore, the ABL information correcting unit 306 omits the correction of the ABL information ABL_DATA and outputs the ABL information ABL_DATA as the ABL information ABL_REV. Accordingly, processing load on the display apparatus B 108 can be reduced and, at the same time, display performance of the display apparatus B 108 can be fully utilized.

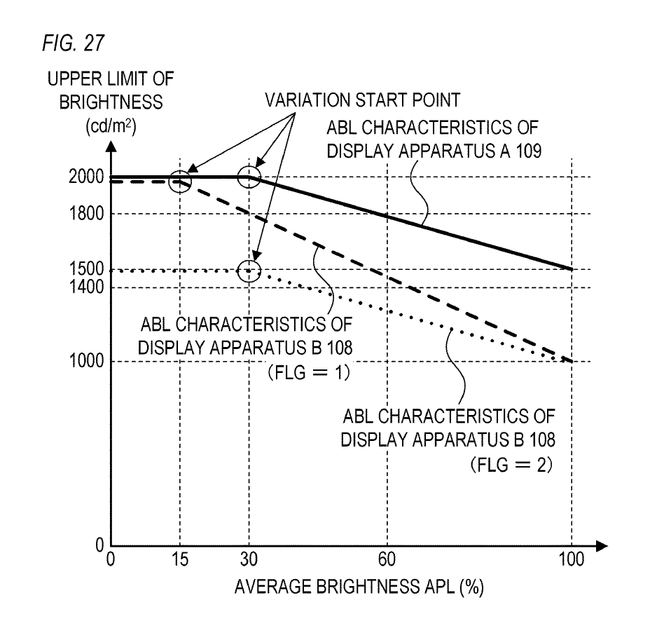

A case will now be considered where the ABL characteristics of the display apparatus A 109 are the characteristics depicted by a thick solid line in FIG. 27, the ABL characteristics of the display apparatus B 108 are the characteristics depicted by a thick dashed line in FIG. 27, and the determination result value FLG is “1”. In this case, since correction of the ABL information ABL_DATA is omitted, the ABL characteristics of the display apparatus B 108 do not change from the characteristics depicted by the thick dashed line in FIG. 27.

A case where the determination result value FLG=2 will now be described. As described earlier, the determination result value FLG=2 corresponds to a determination result of “the display apparatus B 108 is incapable of realizing display with the same display brightness as the display brightness of the display apparatus A 109” and a determination result of “the processing target frame is a frame of a brightness change scene”. In a brightness change scene, since a change in the brightness of the image data IDATA between frames is large, a difference in the manner of change in the second correspondence relationship between frames and the manner of change in the first correspondence relationship between frames is large. In addition, in a brightness change scene, flicker of the second upper limit, flicker of the display brightness of the display apparatus B 108, and the like occur in large amounts. Therefore, the ABL information correcting unit 306 corrects the ABL information ABL_DATA so that a manner of change in the second upper limit with respect to a change in the average brightness APL approaches a manner of change in the first upper limit with respect to a change in the average brightness APL. In this case, a display brightness of no more than the second upper limit (the ABL information ABL_DATA) before correction is obtained as the second upper limit (the ABL information ABL_REV) after the correction. Accordingly, the difference in the manner of change in the second correspondence relationship between frames and the manner of change in the first correspondence relationship between frames can be reduced. In addition, the flicker of the second upper limit, the flicker of the display brightness of the display apparatus B 108, and the like can also be reduced. As a result, an image with an appearance resembling an appearance of the image on the display apparatus A 109 can be displayed by the display apparatus B 108.

A case will now be considered where the ABL characteristics of the display apparatus A 109 are the characteristics depicted by a thick solid line in FIG. 27, the ABL characteristics of the display apparatus B 108 before correction are the characteristics depicted by a thick dashed line in FIG. 27, and the determination result value FLG is “2”. In this case, for example, the ABL information ABL_DATA is corrected so that the characteristics depicted by a dotted line in FIG. 27 are obtained as the ABL characteristics of the display apparatus B 108 after the correction. In FIG. 27, a variation start point of the ABL characteristics of the display apparatus A 109 is a combination of the average brightness APL (first threshold) 30% and the second upper limit 2000 [cd/m²]. In addition, a variation start point of the ABL characteristics of the display apparatus B 108 has been changed from a combination of the average brightness APL (second threshold) 15% and the second upper limit 2000 [cd/m²] to a combination of the average brightness APL 30% and the second upper limit 1500 [cd/m²]. Therefore, the average brightness APL corresponding to the variation start point of the ABL characteristics of the display apparatus B 108 after the correction matches the average brightness APL corresponding to the variation start point of the ABL characteristics of the display apparatus A 109. Furthermore, in a range of the average brightness APL of no more than 30% (the first threshold; the second threshold after correction), a gradient of the ABL characteristics of the display apparatus B 108 after correction and a gradient of the ABL characteristics of the display apparatus A 109 are both “0”. In addition, even in a range of the average brightness APL of at least 30%, a gradient of the ABL characteristics of the display apparatus B 108 after correction matches a gradient of the ABL characteristics of the display apparatus A 109.

Moreover, a method of correcting the second correspondence relationship is not limited to the method described above. For example, the second correspondence relationship may be corrected so that only one of the second threshold and the second upper limit corresponding to the second threshold is changed. The brightness change scene determination process need not be performed. In a case where it is determined that “the display apparatus B 108 is incapable of realizing display with the same display brightness as the display brightness of the display apparatus A 109”, the process described above corresponding to the determination result value FLG=2 may always be performed as the process of correcting the second correspondence relationship. The number of types of the determination result value FLG may be more or less than three types (“0”, “1”, and “2”). For example, the number of types of the determination result value FLG can be increased by using more detailed conditions, conditions with greater variety, and the like in the processes performed by the display feasibility determining unit 305 (the display feasibility determination process, the brightness change scene determination process, and the like). A case where the number of types of the determination result value FLG is larger than three will now be considered. In this case, for example, with respect to a determination result of “the display apparatus B 108 is incapable of realizing display with the same display brightness as the display brightness of the display apparatus A 109”, intermediate characteristics which interpolate between the characteristics depicted by the thick dashed line in FIG. 27 and the characteristics depicted by the dotted line in FIG. 27 are further used. Accordingly, screen transitions can be performed in a smoother manner.

For each frame of the moving image data 107, the gain converting unit 307 converts the ABL information ABL_REV output from the ABL information correcting unit 306 into a gain value RGB_GAIN. In addition, the gain converting unit 307 outputs the gain value RGB_GAIN. The gain value RGB_GAIN is a gain value by which a gradation value (an R value, a G value, and a B value) of the image data GDATA output from the gamma conversion unit 301 is multiplied. In the present embodiment, the gain converting unit 307 calculates the gain value RGB_GAIN using Expression 4 below. According to Expression 4, a value within a range of 0 to 1 is obtained as the gain value RGB_GAIN. In Expression 4, “YPeak” denotes an upper limit of the brightness of the image data IDATA (brightness depicted by the thick solid lines in FIGS. 23 and 24).

RGB_GAIN=YPeak/ABL_REV (Expression 4)

Moreover, a correction parameter and a method of determining the correction parameter are not limited to those described above. For example, an offset value to be added to a gradation value may be determined as a correction parameter. A correction parameter for correcting the R value, a correction parameter for correcting the G value, and a correction parameter for correcting the B value may be determined individually.

For each frame of the moving image data 107, the correcting unit 308 corrects each gradation value of the image data GDATA output from the gamma conversion unit 301 based on the gain value RGB_GAIN output from the gain converting unit 307. Specifically, as represented by Expression 5 below, the correcting unit 308 multiplies each gradation value of the image data GDATA with the gain value RGB_GAIN. Accordingly, image data LDATA is generated. The correcting unit 308 outputs the image data LDATA. In Expression 5, “GRAD_GDATA” denotes a gradation value of the image data GDATA and “GRAD_LDATA” denotes a gradation value of the image data LDATA.

GRAD_LDATA=GRAD_GDATA×RGB_GAIN (Expression 5)

A display unit 309 displays an image in accordance with the image data LDATA output from the correcting unit 308. The use of the image data LDATA output from the correcting unit 308 by the display unit 309 realizes display with display brightness in accordance with the second correspondence relationship after correction. As the display unit 309, for example, an organic EL display panel, a plasma display panel, or the like is used. Alternatively, a combination of a light-emitting unit and a display panel which displays images by transmitting light from the light-emitting unit may be used as the display unit 309.

As described above, according to the present embodiment, brightness information recorded in the first to third embodiments is acquired and the second correspondence relationship is corrected based on the brightness information. Accordingly, display intended by the user can be performed. Specifically, an image with an appearance resembling an appearance of the image on the display apparatus A 109 (an appearance at the time of adjustment of a processing parameter) can be displayed by the display apparatus B 108.

Moreover, each of the thresholds described above may be a fixed value set by a manufacturer, a value that can be changed by the user, or a value automatically determined based on a use environment of the display apparatus B 108 or the like.

While an example in which the display brightness of the display apparatus B 108 is corrected by correcting image data has been described in the present embodiment, a method of correcting the display brightness of the display apparatus B 108 is not limited thereto. For example, the display brightness of the display apparatus B 108 may be corrected by correcting the emission brightness of a light-emitting unit such as a backlight module.

### Fifth Embodiment

A fifth embodiment of the present invention will be described below. Hereinafter, points (configurations and processes) that differ from those of the fourth embodiment will be described in detail and descriptions of points that are the same as those of the fourth embodiment will be omitted. In the present embodiment, an example has been described in which display control is performed so that an image with an appearance resembling an appearance of the image on the display apparatus A 109 is displayed by the display apparatus B 108. In the present embodiment, an example in which an appearance of a display image on the display apparatus B 108 is switchable will be described.

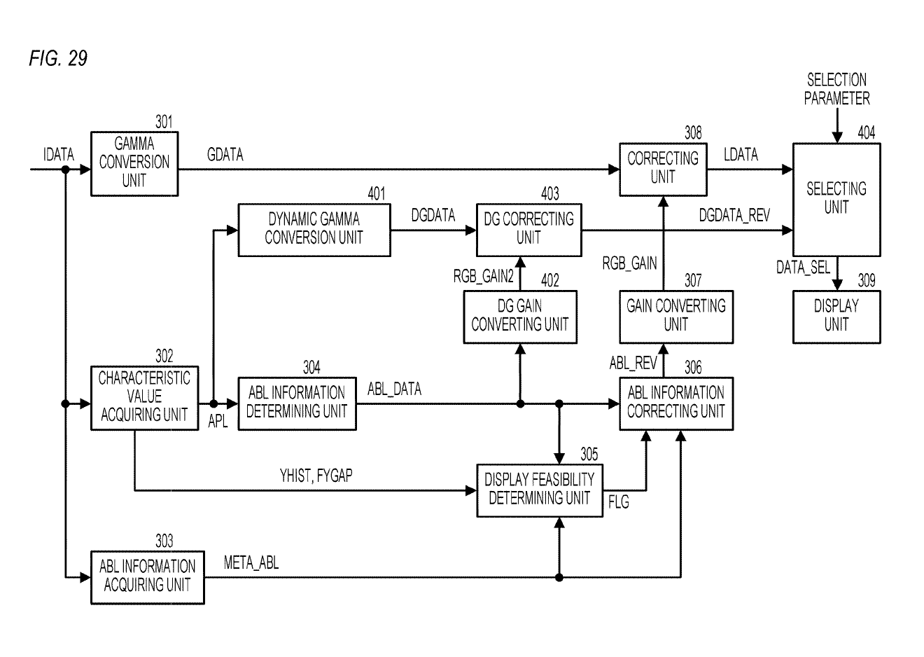

FIG. 29 is a diagram showing an example of a configuration of the display apparatus B 108 according to the present embodiment. In FIG. 29, same functional units as in the fourth embodiment are assigned same reference characters as in the fourth embodiment.

For each frame of the moving image data 107, a dynamic gamma conversion unit 401 applies a dynamic gamma conversion process to image data IDATA to generate image data DGDATA. Subsequently, the dynamic gamma conversion unit 401 outputs the image data DGDATA of each frame to a DG correcting unit 403. The dynamic gamma conversion process refers to a gamma conversion process in which a gamma curve is adaptively changed based on the image data IDATA.

In the present embodiment, a gamma curve is determined based on the brightness histogram YHIST acquired by the characteristic value acquiring unit 302. Specifically, a gamma curve is determined so that a larger number of gradation values are assigned to a range of brightness values Yd with high frequencies as compared to a range of brightness values Yd with low frequencies. A general method such as a frequency accumulation method can be used as a method of determining a gamma curve.

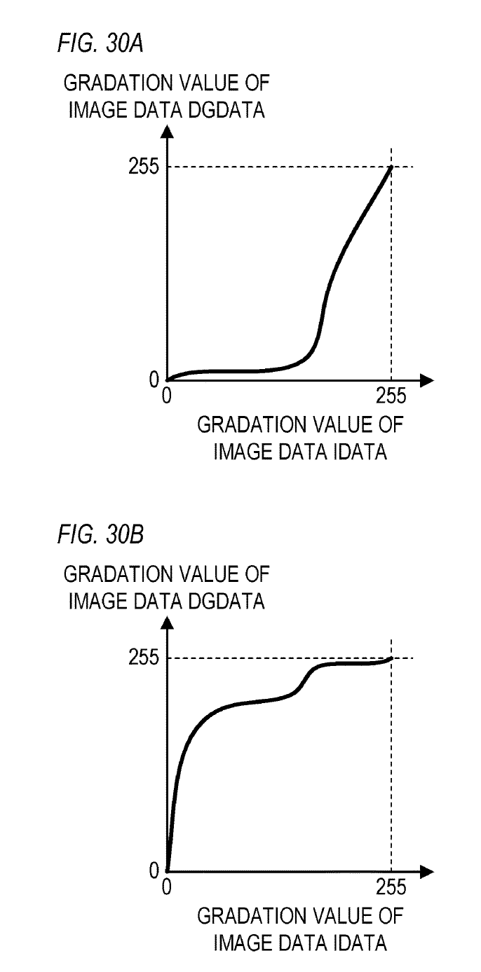

FIGS. 30A and 30B show examples of a gamma curve. For example, in a case where the frequency of low brightness (small brightness values Yd) is low and the frequency of high brightness (large brightness values Yd) is high, a gamma curve such as that shown in FIG. 30A is determined and used in the dynamic gamma conversion process. In a case where the frequency of low brightness is high and the frequency of high brightness is low, a gamma curve such as that shown in FIG. 30B is determined and used in the dynamic gamma conversion process.

For each frame of the moving image data 107, a DG gain converting unit 402 converts the ABL information ABL_DATA output from the ABL information determining unit 304 into a gain value RGB_GAIN2. In addition, the DG gain converting unit 402 outputs the gain value RGB_GAIN2. The gain value RGB_GAIN2 is a gain value by which a gradation value (an R value, a G value, and a B value) of the image data DGDATA output from the dynamic gamma conversion unit 401 is multiplied. A calculation method of the gain value RGB_GAIN2 is similar to the calculation method of the gain value RGB_GAIN.

For each frame of the moving image data 107, the DG correcting unit 403 corrects each gradation value of the image data DGDATA output from the dynamic gamma conversion unit 401 based on the gain value RGB_GAIN2 output from the DG gain converting unit 402. Accordingly, image data DGDATA_REV is generated. The DG correcting unit 403 outputs the image data DGDATA_REV. A method of correcting the image data DGDATA is similar to the method of calculating the image data GDATA.

A selecting unit 404 selects and executes any of a plurality of display controls determined in advance. In the present embodiment, display control is selected and executed in accordance with an operation performed by the user on the display apparatus B 108. Moreover, a method of selecting display control is not particularly limited. For example, display control may be automatically selected based on a use environment of the display apparatus B 108, the moving image data 107, and the like.

In the present embodiment, a selection parameter that is a 1-bit selection signal is input to the selecting unit 404 in accordance with the operation described above related to the selection of display control. In a case where the selection parameter is “0”, the selecting unit 404 selects a dynamic gamma mode as a display mode (operating mode) and performs display control in accordance with the dynamic gamma mode. Specifically, in the dynamic gamma mode, the selecting unit 404 performs display control involving selecting the image data DGDATA_REV after being subjected to a dynamic gamma conversion process and outputting the image data DGDATA_REV to the display unit 309. On the other hand, in a case where the selection parameter is “1”, the selecting unit 404 selects a reproduction display mode as the display mode and performs display control in accordance with the reproduction display mode. Specifically, in the reproduction display mode, the selecting unit 404 performs display control involving selecting the image data LDATA reflecting the second correspondence relationship (ABL information ABL_REV) after correction by the ABL information correcting unit 306 and outputting the image data LDATA to the display unit 309. In other words, in the reproduction display mode, display control similar to the first embodiment (display control in which an image based on the image data IDATA is displayed by the display unit 309 in accordance with the second correspondence relationship after correction by the ABL information correcting unit 306). Therefore, in FIG. 29, image data DATA_SEL that is output from the selecting unit 404 to the display unit 309 is the image data DGDATA_REV or the image data LDATA.

Moreover, while an example of a case where there are two types of display control and the number of bits of a selection parameter is one has been described in the present embodiment, the number of types of display control, the number of bits of a selection parameter, and the like are not particularly limited. For example, the number of types of display control may be three or more and the number of bits of a selection parameter may be two or more. Other display controls include display control corresponding to the loading type 1 described in the first embodiment, display control corresponding to the loading type 2 described in the first embodiment, and the like.

As described above, according to the present embodiment, any of a plurality of display controls is selected and executed. Accordingly, convenience of the display apparatus B 108 (image processing apparatus) can be improved. For example, by using the display apparatus B 108 according to the present embodiment, the user can confirm an image in various appearances. Specifically, the user can confirm an image with an appearance suiting the user's preference.

### Sixth Embodiment

A sixth embodiment of the present invention will be described below. Hereinafter, points (configurations and processes) that differ from those of the fourth and fifth embodiments will be described in detail and descriptions of points that are the same as those of the fourth and fifth embodiments will be omitted. With the method according to the fourth embodiment, the display brightness of the display apparatus B 108 may be controlled to a display brightness that is lower than the display brightness of the display apparatus A 109 (for example, a case of the determination result value FLG=2). In the present embodiment, an example will be described in which a decrease in the display brightness of the display apparatus B 108 is controllable.

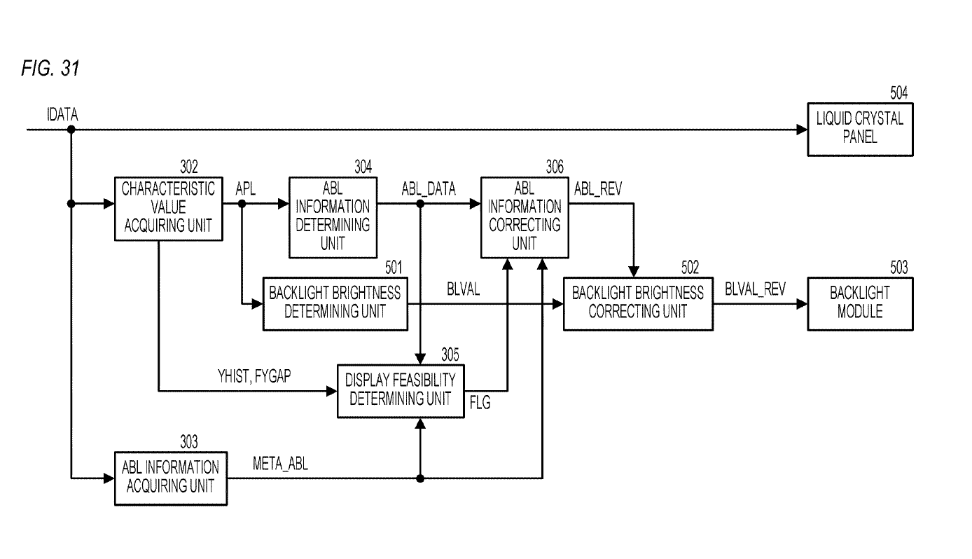

FIG. 31 is a diagram showing an example of a configuration of the display apparatus B 108 according to the present embodiment. In FIG. 31, same functional units as in the fourth embodiment are assigned same reference characters as in the fourth embodiment.

For each frame of the moving image data 107, a backlight brightness determining unit 501 determines an emission brightness BLVAL of a backlight module 503 based on a brightness characteristic value acquired by the characteristic value acquiring unit 302. In addition, the backlight brightness determining unit 501 outputs the emission brightness BLVAL. In the present embodiment, the emission brightness BLVAL is determined based on the average brightness APL. In the present embodiment, a boost process of increasing the emission brightness of the backlight module 503 may be performed. Therefore, the emission brightness BLVAL is determined so that leeway is created in power consumption in a case where the boost process is not performed.

For each frame of the moving image data 107, a backlight brightness correcting unit 502 appropriately corrects the emission brightness BLVAL from the backlight brightness determining unit 501 based on the ABL information ABL_REV from the ABL information correcting unit 306. In addition, the backlight brightness correcting unit 502 outputs an emission brightness BLVAL_REV after correction to the backlight module 503. By appropriately correcting the emission brightness BLVAL based on the ABL information ABL_REV, the second correspondence relationship is appropriately corrected in a similar manner to the first embodiment.

In addition, the backlight brightness correcting unit 502 sets a boost mode or cancels a boost mode setting in accordance with an operation performed by the user on the display apparatus B 108. Specifically, a boost setting parameter BOOST_SEL is input to the backlight brightness correcting unit 502 in accordance with the operation related to the boost mode setting.

In a case where the boost setting parameter BOOST_SEL is “0”, the backlight brightness correcting unit 502 sets a normal mode as a display mode (operating mode). In a case where the boost setting parameter BOOST_SEL is “0” and the boost mode has already been set, the boost mode setting is canceled and the normal mode is set. In other words, the display mode is switched from the boost mode to the normal mode. Subsequently, the backlight brightness correcting unit 502 outputs an emission brightness after correction based on the ABL information ABL_REV as the emission brightness BLVAL_REV. As a result, display similar to the fourth embodiment is performed on the display apparatus B 108.

In a case where the boost setting parameter BOOST_SEL is “1”, the backlight brightness correcting unit 502 sets the boost mode as the display mode. In addition, the backlight brightness correcting unit 502 generates the emission brightness BLVAL_REV by a boost process which increases the emission brightness after correction based on the ABL information ABL_REV. Subsequently, the backlight brightness correcting unit 502 outputs the emission brightness BLVAL_REV. Using the emission brightness BLVAL_REV generated by the boost process enables the display brightness of an entire screen of the display apparatus B 108 to be increased from a display brightness in accordance with the second correspondence relationship after correction based on the ABL information ABL_REV.

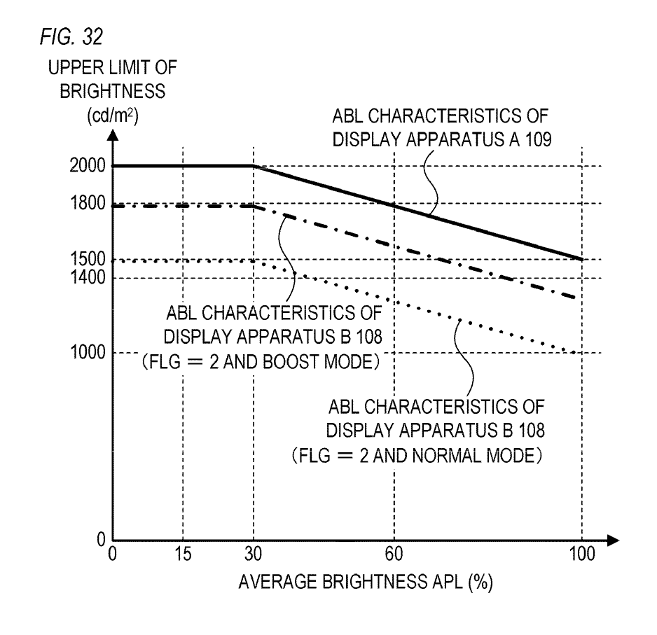

FIG. 32 shows an example of ABL characteristics in the normal mode and an example of ABL characteristics in the boost mode. In FIG. 32, a thick solid line depicts the ABL characteristics of the display apparatus A 109. In addition, a dotted line depicts the ABL characteristics of the display apparatus B 108 in a case where the normal mode is set and the determination result value FLG is “2”. In FIG. 32, a display brightness (second upper limit) of the dotted line is lower than a display brightness (first upper limit) of the thick solid line. Therefore, in a case where the normal mode is set and the determination result value FLG is “2”, the display brightness of the display apparatus B 108 is controlled to a display brightness that is lower than the display brightness of the display apparatus A 109. In other words, with the method according to FIG. 4, in a case where the determination result value FLG is “2”, the display brightness of the display apparatus B 108 is controlled to a display brightness that is lower than the display brightness of the display apparatus A 109.

In FIG. 32, a thick dashed-dotted line depicts the ABL characteristics of the display apparatus B 108 in a case where the boost mode is set and the determination result value FLG is “2”. In FIG. 32, a display brightness (second upper limit) of the thick dashed-dotted line is higher than the display brightness (second upper limit) of the dotted line. Therefore, by setting the boost mode, a decline in the display brightness of the display apparatus B 108 in a case where the determination result value FLG is “2” can be suppressed. As a result, in a case where the determination result value FLG=2, a display brightness which is closer to the display brightness of the display apparatus A 109 can be obtained as the display brightness of the display apparatus B 108.

For each frame of the moving image data 107, the backlight module 503 emits light in accordance with the emission brightness BLVAL_REV from the backlight brightness correcting unit 502. For each frame of the moving image data 107, a liquid crystal panel 504 controls transmittance (an aperture ratio) of each liquid crystal element included in the liquid crystal panel 504 based on the image data IDATA. An image is displayed on a screen as light emitted from the backlight module 503 is transmitted through each liquid crystal element of the liquid crystal panel 504.

As described above, in the present embodiment, a boost process can be executed. Accordingly, a decline in the display brightness of the display apparatus B 108 can be suppressed. For example, a decline in the display brightness of the display apparatus B 108 in a case where the determination result value FLG is “2” can be suppressed. As a result, in a case where the determination result value FLG=2, a display brightness which is closer to the display brightness of the display apparatus A 109 can be obtained as the display brightness of the display apparatus B 108. In addition, by performing the boost process in a case where the average brightness APL is high, a decline in the display brightness of the display apparatus B 108 attributable to an increase in the average brightness APL can also be suppressed.

Moreover, while an example in which a boost process of increasing the display brightness of an entire screen of the display apparatus B 108 has been described in the present embodiment, the display brightness of a part of the screen may be increased by the boost process. For example, only the display brightness of a bright image region may be increased by the boost process.

Moreover, an example in which the display apparatus B 108 is a liquid crystal display apparatus has been described in the present embodiment. In addition, an example in which a process of increasing the emission brightness of the backlight module 503 is performed as the boost process has been described. However, the display apparatus B 108 and the boost process are not limited thereto. For example, the display apparatus B 108 may be a self-luminous display apparatus such as an organic EL display apparatus. In addition, a process of increasing the emission brightness of a light-emitting element such as an organic EL element may be performed as the boost process.

Moreover, an amount of increase in emission brightness due to the boost process is not particularly limited. For example, the amount of increase in the emission brightness may be a fixed value set by a manufacturer, a value that can be changed by the user, or a value automatically determined based on a use environment of the display apparatus or the like. The amount of increase in the emission brightness may be automatically determined based on the first correspondence relationship, the second correspondence relationship after correction, or the like so that the display brightness of the display apparatus B 108 approaches a display brightness in accordance with the first correspondence relationship (the display brightness of the display apparatus A 109).

Moreover, while an example in which the boost process is executed in accordance with an operation performed by the user has been described in the present embodiment, execution/non-execution of the boost process may be automatically switched. For example, execution/non-execution of the boost process may be automatically switched so that the boost process is only performed in a case where the display brightness in accordance with the second correspondence relationship after correction (the display brightness of the display apparatus B 108) is lower than the display brightness in accordance with the first correspondence relationship.

### Seventh Embodiment

A seventh embodiment of the present invention will be described below. Hereinafter, points (configurations and processes) that differ from those of the fourth to sixth embodiments will be described in detail and descriptions of points that are the same as those of the fourth to sixth embodiments will be omitted. In the fourth embodiment, the display apparatus B 108 performs a display feasibility determination process and a brightness change scene determination process and generates the determination result value FLG. In the present embodiment, an example will be described in which, before the moving image data is input to the display apparatus B 108, an apparatus that differs from the display apparatus B 108 performs the display feasibility determination process and the brightness change scene determination process in advance and generates the determination result value FLG in advance.

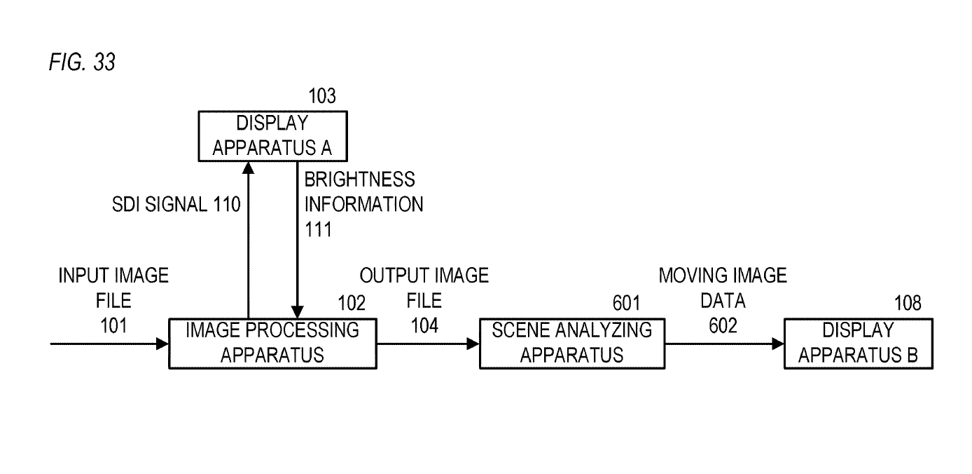

FIG. 33 is a diagram showing an example of a configuration of a display system (an image processing system) according to the present embodiment. In FIG. 33, same articles (apparatuses, functional units, data, and signals) as in the fourth embodiment are assigned same reference characters as in the fourth embodiment.

A scene analyzing apparatus 601 acquires the output image file 104 from the image processing apparatus 102 (the image storage unit 201) and converts the acquired output image file 104 into the moving image data 107. In addition, the scene analyzing apparatus 601 performs a display feasibility determination process and a brightness change scene determination process using the moving image data 107 and generates the determination result value FLG of each frame. Then, by adding (describing) the determination result value FLG to metadata of each frame of the moving image data 107, the scene analyzing apparatus 601 generates moving image data 602. Subsequently, the scene analyzing apparatus 601 outputs the moving image data 602 to the display apparatus B 108.

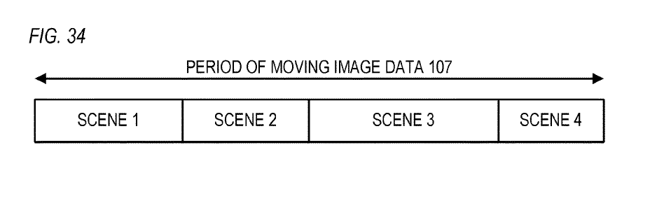

In the brightness change scene determination process by the scene analyzing apparatus 601 and the like, a period of the moving image data 107 is divided into at least one scene and the moving image data 107 is individually analyzed for each scene. FIG. 34 shows an example of a situation where the period of the moving image data 107 is divided into at least one scene. In the example shown in FIG. 34, the period of the moving image data 107 is divided into four scenes 1 to 4. A general method can be used as a method of dividing (detecting) scenes. For example, a method can be used in which a time position where a magnitude of change in the average brightness APL equals a threshold is detected as a time position of a scene change.

A method of the display feasibility determination process by the scene analyzing apparatus 601 is basically similar to the method according to the fourth embodiment. In addition, a method of the brightness change scene determination process by the scene analyzing apparatus 601 is also basically similar to the method according to the fourth embodiment. However, in the fourth embodiment, a highly accurate process may not be performed as the brightness change scene determination process in order to reduce the amount of time from a timing at which moving image data is input to the display apparatus B 108 to a timing at which display is started on the display apparatus B 108. For example, in the brightness change scene determination process, only a few frames including a processing target frame may be used. In the present embodiment, the brightness change scene determination process by the scene analyzing apparatus 601 does not affect the amount of time described above. Therefore, the scene analyzing apparatus 601 can perform a process with higher accuracy than in the fourth embodiment as the brightness change scene determination process. For example, in the brightness change scene determination process, the scene analyzing apparatus 601 can use all of the frames of a scene obtained by division. In a similar manner, the scene analyzing apparatus 601 can perform a process with higher accuracy than in the fourth embodiment as the display feasibility determination process.

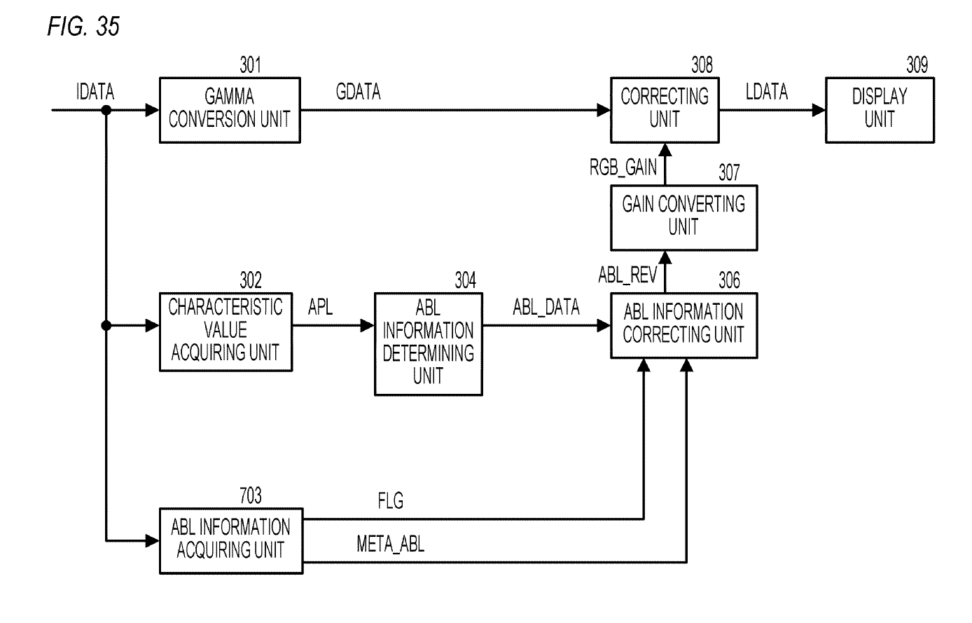

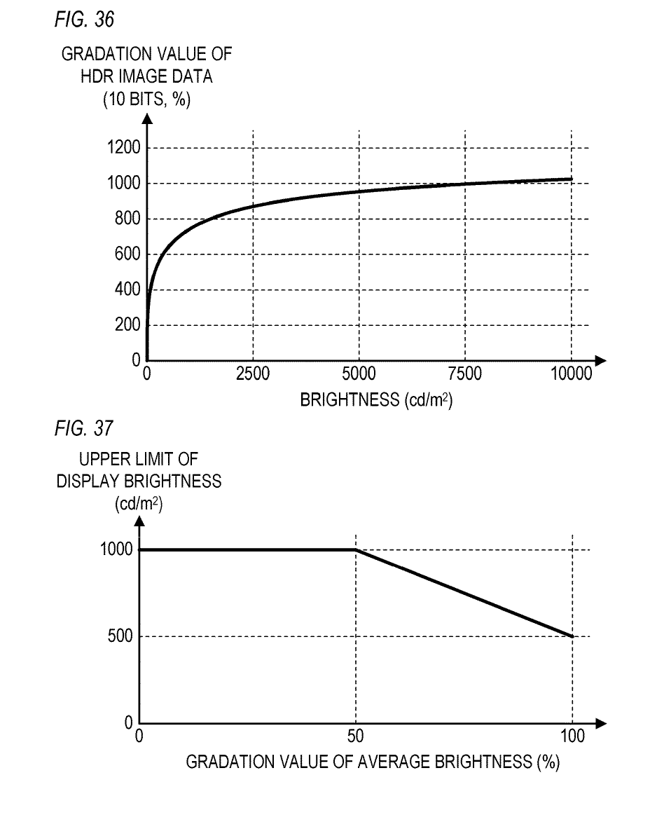

FIG. 35 is a diagram showing an example of a configuration of the display apparatus B 108 according to the present embodiment. In FIG. 35, same functional units as in the fourth embodiment are assigned same reference characters as in the fourth embodiment.

For each frame of the moving image data 602, an ABL information acquiring unit 703 extracts the ABL information META_ABL and the determination result value FLG from metadata of the image data IDATA. In addition, the ABL information acquiring unit 703 outputs the ABL information META_ABL and the determination result value FLG to the ABL information correcting unit 306.

As described above, according to the present embodiment, the determination result value FLG is generated by an apparatus that differs from the display apparatus B 108. Accordingly, a value representing a determination result with higher accuracy can be obtained as the determination result value FLG and a process with higher accuracy can be performed as a process using the determination result value FLG. In addition, since the display apparatus B 108 need not generate the determination result value FLG, a processing load on the display apparatus B 108 can be reduced.

Moreover, the display apparatus B 108 may individually acquire a result of the display feasibility determination process and a result of the brightness change scene determination process. An apparatus performing the display feasibility determination process and an apparatus performing the brightness change scene determination process may differ from each other. One of the display feasibility determination process and the brightness change scene determination process may be performed by an apparatus that differs from the display apparatus B 108, and the other of the display feasibility determination process and the brightness change scene determination process may be performed by the display apparatus B 108.

Moreover, each functional unit of the apparatuses according to the first to seventh embodiments may or may not be individual hardware. Functions of two or more functional units may be realized by common hardware. Each of a plurality of functions of a single functional unit may be realized by individual hardware. Two or more functions of a single functional unit may be realized by common hardware. In addition, each functional unit may or may not be realized by hardware. For example, an apparatus may include a processor and a memory storing a control program. In addition, functions of at least apart of the functional units included in the apparatus may be realized by having the processor read the control program from the memory and execute the control program.

It is to be understood that the first to seventh embodiments are merely examples and that configurations obtained by appropriately modifying and altering the configurations of the first to seventh embodiments without departing from the spirit and scope of the present invention are also included in the present invention.

Configurations obtained by appropriately combining the configurations of the first to seventh embodiments are also included in the present invention.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to readout and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-144282, filed on Jul. 22, 2016, which is hereby incorporated by reference herein in its entirety.

What is claimed is:

1. An image processing apparatus, comprising:
a determining unit configured to determine a parameter to be used in predetermined image processing in accordance with an operation that is performed by a user after an image based on target image data is displayed on a display unit;
a generating unit configured to generate processed image data by applying the predetermined image processing using the parameter determined by the determining unit to the target image data;
an acquiring unit configured to acquire brightness information related to a correspondence relationship between a display brightness of the display unit and a brightness of the processed image data; and
a recording unit configured to record, in a storage unit, the processed image data generated by the generating unit and the brightness information acquired by the acquiring unit.

2. The image processing apparatus according to claim 1, wherein
the brightness information indicates at least any of an upper limit of the display brightness, a lower limit of the display brightness, a type of change in the display brightness with respect to a change in the brightness of the processed image data, and a correspondence relationship between a brightness characteristic value of the processed image data and a range of the display brightness.

3. The image processing apparatus according to claim 2, wherein
the type is:
a type in which the display brightness changes linearly with respect to a change in the brightness of the processed image data; or
a type in which a same display brightness as a brightness of the processed image data within a range of the display brightness corresponds to the brightness of the processed image data and the upper limit or the lower limit of the display brightness corresponds to a brightness of the processed image data outside of the range of the display brightness.

4. The image processing apparatus according to claim 1, wherein
the recording unit records the processed image data and the brightness information in the storage unit in association with each other.

5. The image processing apparatus according to claim 1, wherein
the recording unit:
generates brightness converted image data by converting the brightness of the processed image data into a same brightness as the display brightness based on the brightness information; and
records the brightness converted image data in the storage unit.

6. The image processing apparatus according to claim 1, wherein
the display unit is a display apparatus which is separate from the image processing apparatus,
the display apparatus:
acquires the processed image data; and
generates brightness converted image data by converting the brightness of the processed image data into a same brightness as the display brightness, and
the recording unit:
acquires the brightness converted image data from the display apparatus; and
records the acquired brightness converted image data in the storage unit.

7. The image processing apparatus according to claim 1, wherein
the correspondence relationship between the display brightness and the brightness of the processed image data is dependent on a brightness characteristic value of the processed image data, and
the brightness information is information generated based on the brightness characteristic value of the processed image data.

8. The image processing apparatus according to claim 2, wherein
the brightness characteristic value is an average brightness of the processed image data.

9. A display apparatus, comprising:
a determining unit configured to determine, based on a brightness characteristic value of input image data, a correspondence relationship between a display brightness of a display unit and a brightness of the input image data;
the display unit configured to display an image based on the input image data in accordance with the correspondence relationship determined by the determining unit; and
an outputting unit configured to output brightness information related to the correspondence relationship determined by the determining unit, to the display unit or to the outside.

10. The display apparatus according to claim 9, wherein
the determining unit determines an upper limit of the display brightness in accordance with the brightness characteristic value.

11. The display apparatus according to claim 9, further comprising a combining unit configured to generating combined image data by combining graphic image data on the input image data, wherein
the determining unit determines a correspondence relationship between the display brightness and a brightness of the combined image data based on a brightness characteristic value of the combined image data generated by the combining unit, and
the display unit displays an image based on the combined image data.

12. The display apparatus according to claim 9, wherein
the brightness characteristic value is an average brightness of the input image data.

13. An image processing apparatus, comprising:
a first acquiring unit configured to acquire moving image data;
a second acquiring unit configured to acquire, for each frame of the moving image data acquired by the first acquiring unit, brightness information related to a first correspondence relationship that is a correspondence relationship between a display brightness of a first display unit and a brightness of the moving image data;
a third acquiring unit configured to acquire, for each frame, a brightness characteristic value of the moving image data from the moving image data;
a determining unit configured to determine, for each frame, a second correspondence relationship that is a correspondence relationship between a display brightness of a second display unit and the brightness of the moving image data based on the brightness characteristic value acquired by the third acquiring unit;
a fourth acquiring unit configured to acquire, for each frame, a result of a determination on whether or not the second display unit is capable of displaying an image based on the moving image data with a same display brightness as the display brightness of the first display unit; and
a correcting unit configured to correct, for each frame, the second correspondence relationship based on the result of the determination so that a manner of change in the second correspondence relationship between the frames approaches a manner of change in the first correspondence relationship between the frames.

14. The image processing apparatus according to claim 13, wherein
the fourth acquiring unit determines, based on the second correspondence relationship determined by the determining unit and the brightness information acquired by the second acquiring unit, whether or not the second display unit is capable of displaying an image based on the moving image data with a same display brightness as the display brightness of the first display unit.

15. The image processing apparatus according to claim 13, wherein
the correcting unit corrects, with respect to a frame for which the second display unit is determined to be capable of displaying an image based on the moving image data with a same display brightness as the display brightness of the first display unit, the second correspondence relationship so that the second correspondence relationship approximately matches the first correspondence relationship.

16. The image processing apparatus according to claim 13, wherein
a first upper limit that is an upper limit of the display brightness of the first display unit and a second upper limit that is an upper limit of the display brightness of the second display unit are dependent on the brightness characteristic value, and
the correcting unit corrects the second correspondence relationship so that a manner of change in the second upper limit with respect to a change in the brightness characteristic value approaches a manner of change in the first upper limit with respect to the change in the brightness characteristic value.

17. The image processing apparatus according to claim 13, wherein
the third acquiring unit acquires, for each frame, at least any of an average brightness of the moving image data, a histogram of the brightness of the moving image data, and a histogram of a brightness difference from another frame.

18. The image processing apparatus according to claim 13, further comprising a boost unit capable of executing a boost process of increasing a display brightness of at least a part of a screen of the second display unit from a display brightness in accordance with the second correspondence relationship after a correction by the correcting unit.

19. An image processing method, comprising:
a determining step of determining a parameter to be used in predetermined image processing in accordance with an operation that is performed by a user after an image based on target image data is displayed on a display unit;
a generating step of generating processed image data by applying the predetermined image processing using the parameter determined by the determining step to the target image data;
an acquiring step of acquiring brightness information related to a correspondence relationship between a display brightness of the display unit and a brightness of the processed image data; and
a recording step of recording, in a storage unit, the processed image data generated by the generating step and the brightness information acquired by the acquiring step.

20. A method for controlling a display apparatus having a display unit configured to display an image based on input image data, the method comprising:
a determining step of determining, based on a brightness characteristic value of the input image data, a correspondence relationship between a display brightness of the display unit and a brightness of the input image data; and
an outputting step of outputting brightness information related to the correspondence relationship determined by the determining step, to the display unit or to the outside, wherein
the display unit displays the image based on the input image data in accordance with the correspondence relationship determined by the determining step.

21. An image processing method, comprising:
a first acquiring step of acquiring moving image data;
a second acquiring step of acquiring, for each frame of the moving image data acquired by the first acquiring step, brightness information related to a first correspondence relationship that is a correspondence relationship between a display brightness of a first display unit and a brightness of the moving image data;
a third acquiring step of acquiring, for each frame, a brightness characteristic value of the moving image data from the moving image data;
a determining step of determining, for each frame, a second correspondence relationship that is a correspondence relationship between a display brightness of a second display unit and the brightness of the moving image data based on the brightness characteristic value acquired by the third acquiring step;
a fourth acquiring step of acquiring, for each frame, a result of a determination on whether or not the second display unit is capable of displaying an image based on the moving image data with a same display brightness as the display brightness of the first display unit; and
a correcting step of correcting, for each frame, the second correspondence relationship based on the result of the determination so that a manner of change in the second correspondence relationship between the frames approaches a manner of change in the first correspondence relationship between the frames.
